(19) United States
(12) Patent Application Publication
(10) Pub. No.: US 2005/0099562 A1
(43) Pub. Date: May 12, 2005

(54) Stacked phase shift sheet, stacked polarizing plate including the same and image display

(76) Inventors: Yuuichi Nishikouji, Ibaraki-shi (JP); Shinichi Sasaki, Ibaraki-shi (JP); Takashi Yamaoka, Ibaraki-shi (JP); Nao Murakami, Ibaraki-shi (JP); Hiroyuki Yoshimi, Ibaraki-shi (JP); Masaki Hayashi, Ibaraki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/504,486

(22) PCT Filed: Feb. 18, 2003
(86) PCT No.: PCT/JP03/01682

(30) Foreign Application Priority Data
Feb. 19, 2002 (JP) 2002-41687
Feb. 19, 2002 (JP) 2002-41688

(51) Int. Cl. G02F 1/1335

(52) U.S. Cl. 349/117

(57) ABSTRACT

The present invention provides a laminated retardation plate that shows an excellent viewing angle property when used in a liquid crystal display, and that can be decreased in thickness. The laminated retardation plate is formed by laminating an optically anisotropic layer (A) made of a polymer having an in-plane retardation of 20-300 nm and a ratio between a thickness direction retardation and the in-plane retardation of not less than 1.0, and an optically anisotropic layer (B) made of a non-liquid crystalline polymer such as polyimide having an in-plane retardation of not less than 3 nm and a ratio between a thickness direction retardation and the in-plane retardation of not less than 1.0. The thus obtained laminated retardation plate shows excellent optical properties, e.g., an in-plane retardation (Re) of 10 nm or more, and a difference between a thickness direction retardation and the in-plane retardation of 50 nm or more.

### TECHNICAL FIELD

The present invention relates to a laminated retardation plate, a laminated polarizing plate using the same, and various image displays using the same.

### BACKGROUND ART

Conventionally, various image displays require retardation plates with controlled refractive indices in order to realize excellent display grades in all orientations, and the types are selected depending on the display methods or the like of the liquid crystal displays. It should be noted particularly that a VA (vertically aligned) type or an OCB (optically compensated bend) type liquid crystal display requires a retardation plate providing refraction indices (nx, ny, nz) in three axial directions (X-axis, Y-axis and Z-axis) being ‘nx>ny>nz’, i.e., showing an optically negative biaxiality. Known examples of the retardation plate satisfying ‘nx>ny>nz’ include a laminated retardation plate formed by laminating two stretched polymer films subjected to a free-end uniaxial stretching to provide (nx>ny=nz) so that the slow axes within the plane will cross each other at right angles; and a monolayer retardation plate having a refractive index of ‘nx>ny>nz’ controlled by subjecting a polymer film to either a tenter transverse stretching or a biaxial stretching.

### DISCLOSURE OF INVENTION

Although the laminated retardation plate had an advantage of a wide range of retardation values that is obtained by a combination of the stretched films, it also had a disadvantage that lamination of thick films would further increase the film thickness. On the other hand, though the monolayer retardation plate that includes a single layer is advantageous in that it has an optical property of ‘nx>ny>nz’, the disadvantage is that it is thick and provides a narrow range of retardation values. Therefore, the range of the retardation values must be enlarged by lamination of additional retardation films. Furthermore, when this monolayer retardation plate is used for obtaining a retardation value where the thickness direction retardation value is remarkably larger than the in-plane retardation value, an additional retardation film must be laminated further like the case of the laminated retardation plate, and this will increase further the thickness.

A method of using a non-liquid crystalline polymer such as polyimide for manufacturing a monolayer retardation film being thin and satisfying ‘nx>ny>nz’ is also disclosed (see, for example, JP 2000-190385 A). However, when the thickness direction retardation is set to be large, this monolayer retardation film made of polyimide may be colored due to an unclarified reason, and this may degrade the display quality.

Therefore, an object of the present invention is to provide a laminated type retardation plate having an excellent viewing angle property and showing a high contrast when used for a liquid crystal display, which has a large thickness retardation value and reduced thickness, while preventing coloration.

For achieving the above object, a laminated retardation plate of the present invention includes at least two optically anisotropic layers, which includes, at least, an optically anisotropic layer (A) made of a polymer and an optically anisotropic layer (B) made of at least one non-liquid crystalline polymer selected from the group consisting of polyamide, polyimide, polyester, polyaryletherketone, polyetherketone, polyamide imide, and polyesterimide, where an in-plane retardation (Re) represented by the following equation is 10 nm or more, and a difference (Rth−Re) between a thickness direction retardation (Rth) represented by the following equation and the in-plane retardation (Re) is 50 nm or more.
Re=(nx−ny)·d
Rth=(nx−nz)·d

In the above equations, nx, ny, nz respectively indicate refractive indices in an X-axis direction, a Y-axis direction and a Z-axis direction in the laminated retardation plate; the X-axis direction is an axial direction showing a maximum refractive index within the plane of the laminated retardation plate, the Y-axis direction is an axial direction perpendicular to the X-axis within the plane, and the Z-axis direction is a thickness direction perpendicular to the X-axis and the Y-axis; and d indicates a thickness of the laminated retardation plate.

The inventors have found a laminated retardation plate that shows excellent optical properties, such as the in-plane retardation (Re) of 10 nm or more and the difference (Rth−Re) of 50 nm or more, and has a reduced thickness, by laminating the optically anisotropic layer (A) made of a polymer and the optically anisotropic layer (B) made of a non-liquid crystalline polymer such as polyimide. Furthermore, in such a laminated retardation plate, it is possible to prevent coloring that may occur as a result of providing a large retardation in a thickness direction by using a polyimide film alone, as in a conventional technique. Therefore, the laminated retardation plate of the present invention is useful because, for example, when used for various image displays such as a liquid crystal display, the laminated retardation plate of the present invention can show excellent display properties such as a wide-viewing-angle property and furthermore, the thickness of the device itself can be decreased.

### BRIEF DESCRIPTION OF DRAWINGS

FIG. 1 is a cross-sectional view showing one example of a laminated polarizing plate according to an embodiment of the present invention.

FIG. 2 is a cross-sectional view showing one example of a laminated polarizing plate according to another embodiment of the present invention.

FIG. 3 is a cross-sectional view showing one example of a laminated polarizing plate according to still another embodiment of the present invention.

FIG. 4 is a cross-sectional view showing one example of a laminated polarizing plate according to still another embodiment of the present invention.

FIG. 5 is a cross-sectional view showing one example of a laminated polarizing plate according to still another embodiment of the present invention.

FIG. 6 is a cross-sectional view showing one example of a laminated polarizing plate according to still another embodiment of the present invention.

FIG. 7 is a cross-sectional view showing one example of a laminated polarizing plate according to still another embodiment of the present invention.

FIG. 8 is a cross-sectional view showing one example of a laminated polarizing plate according to still another embodiment of the present invention.

### BEST MODE FOR CARRYING OUT THE INVENTION

As mentioned above, a laminated retardation plate of the present invention includes, at least, an optically anisotropic layer (A) made of a polymer and an optically anisotropic layer (B) made of at least one non-liquid crystalline polymer selected from the group consisting of polyamide, polyimide, polyester, polyaryletherketone, polyetherketone, polyamide imide and polyesterimide, and it is characterized in that the in-plane retardation (Re) is 10 nm or more, and the difference (Rth−Re) between the thickness direction retardation (Rth) and the in-plane retardation (Re) is 50 nm or more.

In the laminated retardation plate of the present invention formed by laminating the optically anisotropic layers (A) and (B), the refractive indices in the X-axis, Y-axis and Z-axis satisfy a relationship of ‘nx>ny>nz’ as a whole, furthermore, the Re value is 10 nm or more, and a difference (Rth−Re) between Rth and Re is 50 nm or more. Therefore, for example, in the above-mentioned VA mode liquid crystal display or the OCB mode liquid crystal display, it can compensate sufficiently the birefringence of the liquid crystal cell, thereby providing an excellent effect in enlarging the viewing angle. The above-mentioned effect of enlarging the viewing angle cannot be obtained when the Re value is less than 10 nm or when the Rth−Re is less than 50 nm.

It is preferable that the Re value is in a range of 10 to 500 nm, and more preferably, in a range of 20 to 300 nm. It is also preferable that the value of (Rth−Re) is in a range of 50 to 1,000 nm, more preferably, in a range of 50 to 900 nm, and particularly preferably, in a range of 50 to 800 nm.

The Rth is 60 nm or more, and preferably in a range of 60 to 1500 nm, more preferably, in a range of 60 to 1400 nm, and particularly preferably, in a range of 60 to 1300 nm. Rth/Re for the laminated retardation plate of the present invention is 1 or more.

In the present invention, there is no specific limitation for the optically anisotropic layer (A) as long as it can satisfy the above-mentioned conditions of Re and (Rth−Re) as a whole when combined with the optically anisotropic layer (B). However, for example, it is preferable that the in-plane retardation [Re(A)] represented by the following equation is 20 to 300 nm, and a ratio [Rth(A)/Re(A)] between the thickness direction retardation [Rth(A)] represented by the following equation and the in-plane retardation [Re(A)] is 1.0 or more. In the case where the ratio [Rth(A)/Re(A)] between the thickness direction retardation [Rth(A)] and the in-plane retardation [Re(A)] is less than 1.0, for example, the layer cannot compensate sufficiently the retardation value in the thickness direction when used for a liquid crystal display, and thus reduces the viewing angle range. When the in-plane retardation is less than 20 nm or greater than 300 nm, the viewing angle will be narrower as well. The Rth(A)/Re(A) is, more preferably, 1.2 or more, and particularly preferably, 1.2 to 40.
Re(A)=(nx(A)−ny(A))·d(A)
Rth(A)=(nx(A)−nz(A))·d(A)

In the above equations, nx(A), ny(A), nz(A) respectively indicate refractive indices in an X-axis direction, a Y-axis direction and a Z-axis direction in the optically anisotropic layer (A); the X-axis direction is an axial direction showing a maximum refractive index within the plane of the optically anisotropic layer (A), the Y-axis direction is an axial direction perpendicular to the X-axis within the plane, and the Z-axis direction is a thickness direction perpendicular to the X-axis and the Y-axis; d indicates a thickness of the optically anisotropic layer (A) (the same applies to the following).

For the optically anisotropic layer (B), the refractive indices are not limited particularly as long as it is the above-mentioned optically anisotropic layer made of a non-liquid crystalline polymer. However, for example, the refractive indices in the X-axis, Y-axis and Z-axis can satisfy the relationship of ‘nx(B)>ny(B)>nz(B)’, or a relationship of ‘nx(B)≈ny(B)>nz(B)’. The nx(B), ny(B), and nz(B) respectively indicate refractive indices in the X-axis, Y-axis and Z-axis directions in the optically anisotropic layer (B). The X-axis indicates an axial direction showing a maximum refractive index within the plane of the optically anisotropic layer (B), the Y-axis indicates an axial direction perpendicular to the X-axis within the plane, and the Z-axis indicates a thickness direction perpendicular to the X-axis and the Y-axis (the same applies to the following).

When the optically anisotropic layer (B) shows the relationship of ‘nx(B)>ny(B)>nz(B)’, it is preferable that the in-plane retardation [Re(B)] represented by the following equation is 3 nm or more, and a ratio [Rth(B)/Re(B)] between the thickness direction retardation [Rth(B)] represented by the following equation and the in-plane retardation [Re(B)] is 1.0 or more. In the case where the ratio [Rth(B)/Re(B)] between the thickness direction retardation [Rth(B)] and the in-plane retardation [Re(B)] is less than 1.0, for example, the plate cannot compensate sufficiently the retardation value in the thickness direction when it is used for a liquid crystal display, resulting in a narrower viewing angle. The Re(B) is, more preferably, 3 to 800 nm, and particularly preferably, 5 to 500 nm. The Rth(B)/Re(B) is, more preferably, 1.2 or more, and particularly preferably, 1.2 to 160. In the following equations, d(B) indicates a thickness of the optically anisotropic layer (B) (the same applies to the following).
Re(B)=(nx(B)−ny(B))·d(B)
Rth(B)=(nx(B)−nz(B))·d(B)

Even in the case where the optically anisotropic layer (B) shows the relationship of ‘nx(B)≈ny(B)>nz(B)’, that is, when the in-plane retardation [Re(B)] is substantially 0 nm, the above-mentioned condition for the Re and (Rth−Re) of the laminated retardation plate of the present invention can be satisfied, for example, by setting the in-plane retardation [Re(A)] of the optically anisotropic layer (A) within the above-noted range.

Specific examples of combinations of the optically anisotropic layer (A) and the optically anisotropic layer (B) include, for example, a combination of an optically anisotropic layer (A) having an in-plane retardation [Re(A)] ranging from 20 to 300 nm and a ratio [Rth(A)/Re(A)] between the thickness direction retardation [Rth(A)] and the in-plane retardation [Re(A)] of 1.0 or more, and a optically anisotropic layer (B) having an in-plane retardation [Re(B)] of 3 nm or more and a ratio [Rth(B)/Re(B)] between the thickness direction retardation [Rth(B)] and the in-plane retardation [Re(B)] of 1.0 or more.

The laminated retardation plate of the present invention has an entire thickness of 1 mm or less in general, thus the thickness is sufficiently reduced when compared to the above-mentioned conventional laminated retardation plate. A preferable thickness range is 1 to 500 μm, and particularly preferable range is 5 to 300 μm. The thickness of the laminated retardation plate of the present invention can be decreased to about a half “that of a conventional laminated retardation plate formed by laminating two stretched polymer films of ‘nx=ny>nz’ so that the slow axes within the plane will cross each other at right angles” as mentioned above, for example.

The optically anisotropic layer (A) has a thickness ranging from 1 to 800 μm, or preferably, from 5 to 500 μm, more preferably, from 10 to 400 μm, and particularly preferably, from 50 to 400 μm. The optically anisotropic layer (B) has a thickness ranging from, for example, 1 to 50 μm, more preferably, from 2 to 30 μm, and particularly preferably, from 1 to 20 μm. Since the thickness of the optically anisotropic layer (B) can be decreased sufficiently, the entire thickness of the laminated retardation plate of the present invention can be decreased as well, and the laminated retardation plate will have optical properties improved by lamination of the optically anisotropic layer (A).

Though there is no specific limitation on a material for forming the optically anisotropic layer (A), for example, a polymer that shows positive birefringence is preferred. By selecting the polymer, the in-plane retardation and the thickness direction retardation of the optically anisotropic layer (A) can be increased. In the present invention, “a polymer showing positive birefringence” denotes a polymer that shows a characteristic of maximizing the refraction in the stretching direction when stretching the film. The optically anisotropic layer (A) made of the polymer can be either a stretched film or unstretched film (the same applies to the following).

Since a stretched film can be one embodiment of the optically anisotropic layer (A), for example, the polymer is preferably a thermoplastic polymer that can be stretched easily. Examples of the thermoplastic polymer include polyolefins (e.g., polyethylene and polypropylene), polynorbornene-based polymer, polyester, polyvinyl chloride, polyacrylonitrile, polysulfone, polyarylate, polyvinyl alcohol, polymethacrylate, polyacrylic ester, cellulose ester, and copolymers thereof. These polymers can be used alone, or two or more kinds of polymers can be used in combination. A polymer film described in JP 2001-343529A (WO01/37007) can be also used for the optically anisotropic layer (A). An example of the polymer material is a resin composition containing a thermoplastic resin whose side chain has a substituted or unsubstituted imide group and a thermoplastic resin whose side chain has a substituted or unsubstituted phenyl group and a cyano group. The example is a resin composition having an alternating copolymer including isobutene and N-methylene maleimide and a styrene-acrylonitrile copolymer. The polymer film can be, for example, formed by extruding the resin composition. Preferably, the polymer film has an excellent transparency.

The optically anisotropic layer (B) is formed of a non-liquid crystalline polymer excellent in heat resistance, chemical resistance, transparency or the like, and the examples are polyamide, polyimide, polyester, polyaryletherketone, polyether ketone, polyamide imide, and polyesterimide. Unlike a liquid crystalline material, such a non-liquid crystalline material forms, for example, a film that shows an optical unaxiality of ‘nx>n’ and ‘ny>nz’ due to its own characteristics regardless of alignment of the substrate. Therefore, for example, a substrate used in forming the anisotropic layer (B) is not limited to an alignment substrate, but for example, even an unstretched substrate can be used directly.

These polymers can be used alone, or can be used as a mixture of at least two kinds of polymers having different polyfunctional groups, for example, a mixture of polyaryletherketone and polyamide. Among these polymers, polyimide is especially preferred due to the high transparency, high alignment and high stretching property.

Though the molecular weight of the polymer is not limited particularly, the weight average molecular weight (Mw) is preferably, for example, in a range from 1,000 to 1,000,000, and more preferably, in a range of 2,000 to 500,000. The weight average molecular weight can be measured by a gel permeation chromatography (GPC), using, for example, polyethylene oxide as a standard sample, and DMF (N,N-dimethylformamide) as a solvent.

As the polyimide, it is preferable to use a polyimide that has a high in-plane alignment and is soluble in an organic solvent. For example, it is possible to use a condensation polymer of 9,9-bis(aminoaryl)fluorene and an aromatic tetracarboxylic dianhydride disclosed in JP 2000-511296A, more specifically, a polymer containing at least one repeating unit represented by the formula (1) below.

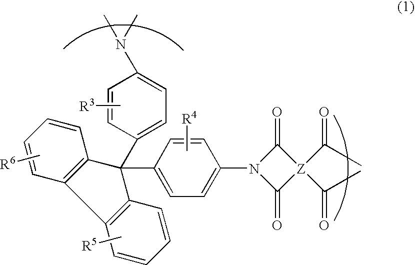

In the above formula (1), R³ to R⁶ are at least one substituent selected independently from the group consisting of hydrogen, halogen, a phenyl group, a phenyl group substituted with 1 to 4 halogen atoms or a C₁₋₁₀ alkyl group, and a C₁₋₁₀ alkyl group. Preferably, R³ to R⁶ are at least one substituent selected independently from the group consisting of halogen, a phenyl group, a phenyl group substituted with 1 to 4 halogen atoms or a C₁₋₁₀ alkyl group, and a C₁₋₁₀ alkyl group.

In the above formula (1), Z is, for example, a C₆₋₂₀ quadrivalent aromatic group, and preferably is a pyromellitic group, a polycyclic aromatic group, a derivative of a polycyclic aromatic group or a group represented by the formula (2) below.

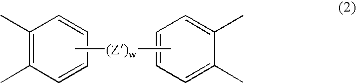

In the formula (2) above, Z′ is, for example, a covalent bond, a C(R⁷)₂ group, a CO group, an O atom, an S atom, an SO₂ group, an Si(C₂H₅)₂ group or an NR⁸ group. When there are plural Z′s, they may be the same or different. Also, w is an integer from 1 to 10. R⁷s independently are hydrogen or C(R⁹)₃. R⁸ is hydrogen, an alkyl group having from 1 to about 20 carbon atoms or a C₆₋₂₀ aryl group, and when there are plural R⁸s, they may be the same or different. R⁹s independently are hydrogen, fluorine or chlorine.

The above-mentioned polycyclic aromatic group may be, for example, a quadrivalent group derived from naphthalene, fluorene, benzofluorene or anthracene. Further, a substituted derivative of the above-mentioned polycyclic aromatic group may be the above-mentioned polycyclic aromatic group substituted with at least one group selected from the group consisting of, for example, a C₁₋₁₀ alkyl group, a fluorinated derivative thereof and halogen such as F and Cl.

Other than the above, homopolymer whose repeating unit is represented by the general formula (3) or (4) below or polyimide whose repeating unit is represented by the general formula (5) below disclosed in JP 8(1996)-511812 A may be used, for example. The polyimide represented by the formula (5) below is a preferable mode of the homopolymer represented by the formula (3).

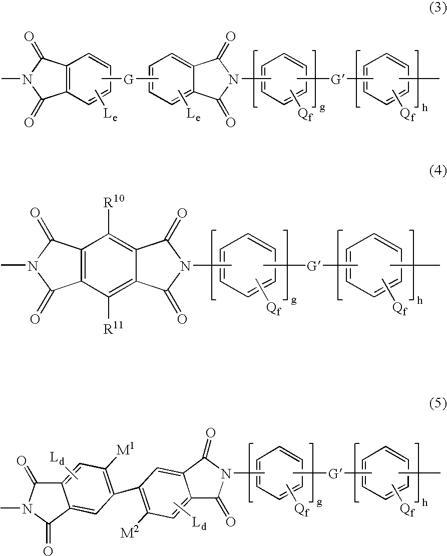

In the above general formulae (3) to (5), G and G′ each are a group selected independently from the group consisting of, for example, a covalent bond, a CH₂ group, a C(CH₃)₂ group, a C(CF)₂ group, a C(CX₃)₂ group (wherein X is halogen), a CO group, an O atom, an S atom, an SO₂ group, an Si(CH₂CH₃)₂ group and an N(CH₃) group, and G and G′ may be the same or different.

In the above formulae (3) and (5), L is a substituent, and d and e indicate the number of substitutions therein. L is, for example, halogen, a C₁₋₃ alkyl group, a halogenated C₁₋₃ alkyl group, a phenyl group or a substituted phenyl group, and when there are plural Ls, they may be the same or different. The above-mentioned substituted phenyl group may be, for example, a substituted phenyl group having at least one substituent selected from the group consisting of halogen, a C₁₋₃ alkyl group and a halogenated C₁₋₃ alkyl group. Also, the abovementioned halogen may be, for example, fluorine, chlorine, bromine or iodine. d is an integer from 0 to 2, and e is an integer from 0 to 3.

In the above formulae (3) to (5), Q is a substituent, and f indicates the number of substitutions therein. Q may be, for example, an atom or a group selected from the group consisting of hydrogen, halogen, an alkyl group, a substituted alkyl group, a nitro group, a cyano group, a thioalkyl group, an alkoxy group, an aryl group, a substituted aryl group, an alkyl ester group and a substituted alkyl ester group and, when there are plural Qs, they may be the same or different. The above-mentioned halogen may be, for example, fluorine, chlorine, bromine or iodine. The above-mentioned substituted alkyl group may be, for example, a halogenated alkyl group. Also, the above-mentioned substituted aryl group may be, for example, a halogenated aryl group. f is an integer from 0 to 4, and g and h respectively are an integer from 0 to 3 and an integer from 1 to 3. Furthermore, it is preferable that g and h are larger than 1.

In the above formula (4), R¹⁰ and R¹¹ are groups selected independently from the group consisting of hydrogen, halogen, a phenyl group, a substituted phenyl group, an alkyl group and a substituted alkyl group. It is particularly preferable that R¹⁰ and R¹¹ independently are a halogenated alkyl group.

In the above formula (5), M¹ and M² may be the same or different and, for example, halogen, a C₁₋₃ alkyl group, a halogenated C₁₋₃ alkyl group, a phenyl group or a substituted phenyl group. The above-mentioned halogen may be, for example, fluorine, chlorine, bromine or iodine. The above-mentioned substituted phenyl group may be, for example, a substituted phenyl group having at least one substituent selected from the group consisting of halogen, a C₁₋₃ alkyl group and a halogenated C₁₋₃ alkyl group.

A specific example of polyimide represented by the formula (3) includes polyimide represented by the formula (6) below.

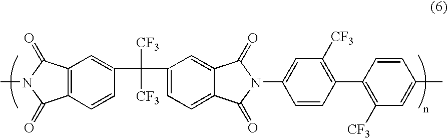

Moreover, the above-mentioned polyimide may be, for example, copolymer obtained by copolymerizing acid dianhydride and diamine other than the above-noted skeleton (the repeating unit) suitably.

The above-mentioned acid dianhydride may be, for example, aromatic tetracarboxylic dianhydride. The aromatic tetracarboxylic dianhydride may be, for example, pyromellitic dianhydride, benzophenone tetracarboxylic dianhydride, naphthalene tetracarboxylic dianhydride, heterocyclic aromatic tetracarboxylic dianhydride or 2,2′-substituted biphenyl tetracarboxylic dianhydride.

The pyromellitic dianhydride may be, for example, pyromellitic dianhydride, 3,6-diphenyl pyromellitic dianhydride, 3,6-bis(trifluoromethyl)pyromellitic dianhydride, 3,6-dibromopyromellitic dianhydride or 3,6-dichloropyromellitic dianhydride. The benzophenone tetracarboxylic dianhydride may be, for example, 3,3′,4,4-benzophenone tetracarboxylic dianhydride, 2,3,3′,4-benzophenone tetracarboxylic dianhydride or 2,2′,3,3′-benzophenone tetracarboxylic dianhydride. The naphthalene tetracarboxylic dianhydride may be, for example, 2,3,6,7-naphthalene-tetracarboxylic dianhydride, 1,2,5,6-naphthalene-tetracarboxylic dianhydride or 2,6-dichloro-naphthalene-1,4,5,8-tetracarboxylic dianhydride. The heterocyclic aromatic tetracarboxylic dianhydride may be, for example, thiophene-2,3,4,5-tetracarboxylic dianhydride, pyrazine-2,3,5,6-tetracarboxylic dianhydride or pyridine-2,3,5,6-tetracarboxylic dianhydride. The 2,2′-substituted biphenyl tetracarboxylic dianhydride may be, for example, 2,2-dibromo-4,4′,5,5′-biphenyl tetracarboxylic dianhydride, 2,2′-dichloro-4,4′,5,5′-biphenyl tetracarboxylic dianhydride or 2,2′-bis(trifluoromethyl)-4,4′,5,5′-biphenyl tetracarboxylic dianhydride.

Other examples of the aromatic tetracarboxylic dianhydride may include 3,3′,4,4′-biphenyl tetracarboxylic dianhydride, bis(2,3-dicarboxyphenyl)methane dianhydride, bis(2,5,6-trifluoro-3,4-dicarboxyphenyl)methane dianhydride, 2,2-bis(3,4-dicarboxyphenyl)-1,1,1,3,3,3-hexafluoropropane dianhydride, 4,4′-(3,4-dicarboxyphenyl)-2,2-diphenylpropane dianhydride, bis(3,4-dicarboxyphenyl)ether dianhydride, 4,4′-oxydiphthalic dianhydride, bis(3,4-dicarboxyphenyl)sulfonic dianhydride, (3,3′,4,4′-diphenylsulfone tetracarboxylic dianhydride), 4,4′-[4,4′-isopropylidene-di(p-phenyleneoxy)]bis(phthalic dianhydride), N,N-(3,4-dicarboxyphenyl)-N-methylamine dianhydride and bis(3,4-dicarboxyphenyl)diethylsilane dianhydride.

Among the above, the aromatic tetracarboxylic dianhydride preferably is 2,2′-substituted biphenyl tetracarboxylic dianhydride, more preferably is 2,2′-bis(trihalomethyl)-4,4,5,5′-biphenyl tetracarboxylic dianhydride, and further preferably is 2,2′-bis(trifluoromethyl)-4,4′,5,5′-biphenyl tetracarboxylic dianhydride.

The above-mentioned diamine may be, for example, aromatic diamine. Specific examples thereof include benzenediamine, diaminobenzophenone, naphthalenediamine, heterocyclic aromatic diamine and other aromatic diamines.

The benzenediamine may be, for example, diamine selected from the group consisting of benzenediamines such as o-, m- and p-phenylenediamine, 2,4-diaminotoluene, 1,4-diamino-2-methoxybenzene, 1,4-diamino-2-phenylbenzene and 1,3-diamino-4-chlorobenzene. Examples of the diaminobenzophenone may include 2,2′-diaminobenzophenone and 3,3′-diaminobenzophenone. The naphthalenediamine may be, for example, 1,8-diaminonaphthalene or 1,5-diaminonaphthalene. Examples of the heterocyclic aromatic diamine may include 2,6-diaminopyridine, 2,4-diaminopyridine and 2,4-diamino-S-triazine.

Further, other than the above, the aromatic diamine may be 4,4′-diaminobiphenyl, 4,4′-diaminodiphenyl methane, 4,4′-(9-fluorenylidene)-dianiline, 2,2′-bis(trifluoromethyl)-4,4′-diaminobiphenyl, 3,3′-dichloro-4,4-diaminodiphenyl methane, 2,2′-dichloro-4,4′-diaminobiphenyl, 2,2′,5,5′-tetrachorobenzidine, 2,2-bis(4-aminophenoxyphenyl)propane, 2,2-bis(4-aminophenyl)propane, 2,2-bis(4-aminophenyl)-1,1,1,3,3,3-hexafluoropropane, 4,4′-diamino diphenyl ether, 3,4′-diamino diphenyl ether, 1,3-bis(3-aminophenoxy)benzene, 1,3-bis(4-aminophenoxy)benzene, 1,4-bis(4-aminophenoxy)benzene, 4,4′-bis(4-aminophenoxy)biphenyl, 4,4′-bis(3-aminophenoxy)biphenyl, 2,2-bis[4-(4-aminophenoxy)phenyl]propane, 2,2-bis[4-(4-aminophenoxy)phenyl]-1,1,1,3,3,3,-hexafluoropropane, 4,4′-diamino diphenyl thioether or 4,4′-diaminodiphenylsulfone.

The polyetherketone as a material for forming the birefingent layer may be, for example, polyaryletherketone represented by the general formula (7) below, which is disclosed in JP 2001-49110A

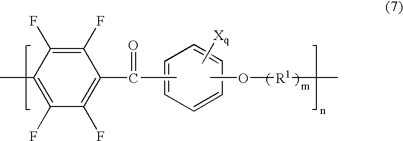

In the above formula (7), X is a substituent, and q is the number of substitutions therein. X is, for example, a halogen atom, a lower alkyl group, a halogenated alkyl group, a lower alkoxy group or a halogenated alkoxy group, and when there are plural Xs, they may be the same or different.

The halogen atom may be, for example, a fluorine atom, a bromine atom, a chorine atom or an iodine atom, and among these, a fluorine atom is preferable. The lower alkyl group preferably is a C₁₋₆ lower straight alkyl group or a C₁₋₆ lower branched alkyl group and more preferably is a C₁₋₄ straight or branched chain alkyl group, for example. More specifically, it preferably is a methyl group, an ethyl group, a propyl group, an isopropyl group, a butyl group, an isobutyl group, a sec-butyl group or a tert-butyl group, and particularly preferably is a methyl group or an ethyl group. The halogenated alkyl group may be, for example, a halide of the above-mentioned lower alkyl group such as a trifluoromethyl group. The lower alkoxy group preferably is a C₁₋₆ straight or branched chain alkoxy group and more preferably is a C₁₋₄ straight or branched chain alkoxy group, for example. More specifically, it further preferably is a methoxy group, an ethoxy group, a propoxy group, an isopropoxy group, a butoxy group, an isobutoxy group, a sec-butoxy group or a tert-butoxy group, and particularly preferably is a methoxy group or an ethoxy group. The halogenated alkoxy group may be, for example, a halide of the above-mentioned lower alkoxy group such as a trifluoromethoxy group.

In the above formula (7), q is an integer from 0 to 4. In the formula (7), it is preferable that q=0 and a carbonyl group and an oxygen atom of an ether that are bonded to both ends of a benzene ring are present at para positions.

Also, in the above formula (7), R¹ is a group represented by the formula (8) below, and m is an integer of 0 or 1.

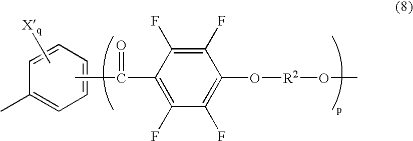

In the above formula (8), X′ is a substituent and is the same as X in the formula (7), for example. In the formula (8), when there are plural X′s, they may be the same or different. q′ indicates the number of substitutions in the X and is an integer from 0 to 4, preferably, q′=0. In addition, p is an integer of 0 or 1.

In the formula (8), R² is a divalent aromatic group. This divalent aromatic group is, for example, an o-, m- or p-phenylene group or a divalent group derived from naphthalene, biphenyl, anthracene, o-, m- or p-terphenyl, phenanthrene, dibenzofuran, biphenyl ether or biphenyl sulfone. In these divalent aromatic groups, hydrogen that is bonded directly to the aromatic may be substituted with a halogen atom, a lower alkyl group or a lower alkoxy group. Among them, the R² preferably is an aromatic group selected from the group consisting of the formulae (9) to (15) below.

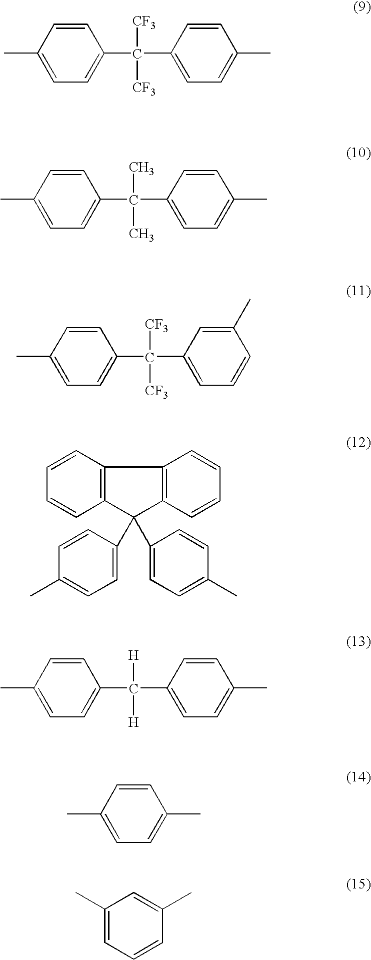

In the above formula (7), the R¹ preferably is a group represented by the formula (16) below, wherein R² and p are equivalent to those in the above-noted formula (8).

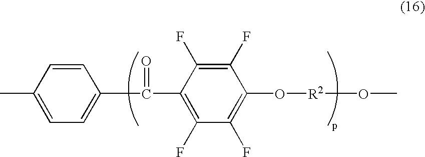

Furthermore, in the formula (7), n indicates a degree of polymerization ranging, for example, from 2 to 5000 and preferably from 5 to 500. The polymerization may be composed of repeating units with the same structure or those with different structures. In the latter case, the polymerization form of the repeating units may be a block polymerization or a random polymerization.

Moreover, it is preferable that an end on a p-tetrafluorobenzoylene group side of the polyaryletherketone represented by the formula (7) is fluorine and an end on an oxyalkylene group side thereof is a hydrogen atom. Such a polyaryletherketone can be represented by the general formula (17) below. In the formula below, n indicates a degree of polymerization as in the formula (7).

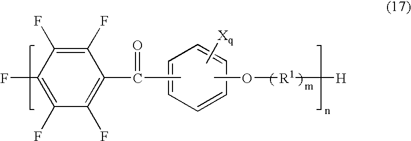

Specific examples of the polyaryletherketone represented by the formula (7) may include those represented by the formulae (18) to (21) below, wherein n indicates a degree of polymerization as in the formula (7).

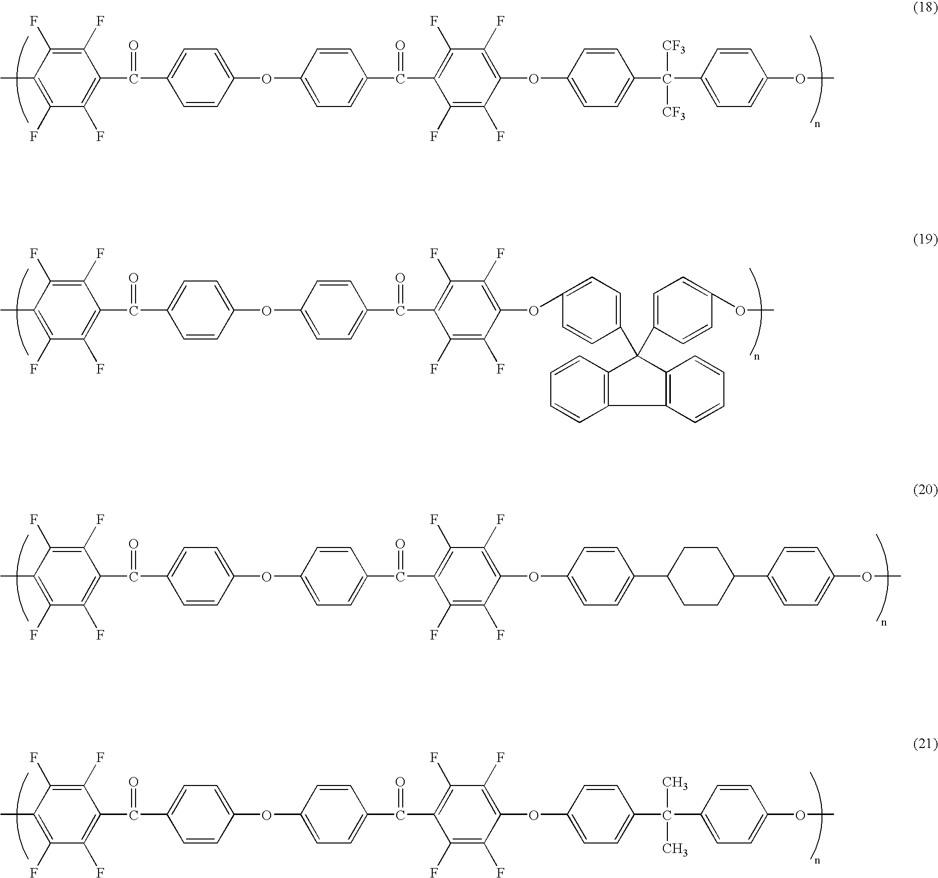

Other than the above, the polyamide or polyester as a material for forming the birefringent layer may be, for example, polyamide or polyester described by JP 10(1998)-508048 A, and their repeating units can be represented by the general formula (22) below.

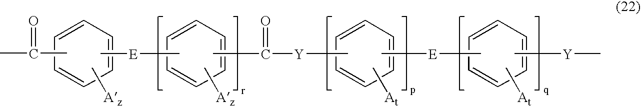

In the above formula (22), Y is O or NH. E is, for example, at least one group selected from the group consisting of a covalent bond, a C₂ alkylene group, a halogenated C₂ alkylene group, a CH₂ group, a C(CX₃)₂ group (wherein X is halogen or hydrogen), a CO group, an O atom, an S atom, an SO₂ group, an Si(R)₂ group and an N(R) group, and Es may be the same or different. In the above-mentioned E, R is at least one of a C₁₋₃ alkyl group and a halogenated C₁₋₃ alkyl group and present at a meta position or a para position with respect to a carbonyl functional group or a Y group.

Further, in the above formula (22), A and A′ are substituents, and t and z respectively indicate the numbers of substitutions therein. Additionally, p is an integer from 0 to 3, q is an integer from 1 to 3, and r is an integer from 0 to 3.

The above-mentioned A is selected from the group consisting of, for example, hydrogen, halogen, a C₁₋₃ alkyl group, a halogenated C₁₋₃ alkyl group, an alkoxy group represented by OR (wherein R is the group defined above), an aryl group, a substituted aryl group by halogenation, a C₁₋₉ alkoxycarbonyl group, a C₁₋₉ alkylcarbonyloxy group, a C₁₋₁₂ aryloxycarbonyl group, a C₁₋₁₂ arylcarbonyloxy group and a substituted derivative thereof, a C₁₋₁₂ arylcarbamoyl group, and a C₁₋₁₂ arylcarbonylamino group and a substituted derivative thereof. When there are plural A′s, they may be the same or different. The above-mentioned A is selected from the group consisting of, for example, halogen, a C₁₋₃ alkyl group, a halogenated C₁₋₃ alkyl group, a phenyl group and a substituted phenyl group and when there are plural As, they may be the same or different. A substituent on a phenyl ring of the substituted phenyl group can be, for example, halogen, a C₁₋₃ alkyl group, a halogenated C₁₋₃ alkyl group or a combination thereof. The t is an integer from 0 to 4, and the z is an integer from 0 to 3.

Among the repeating units of the polyamide or polyester represented by the formula (22) above, the repeating unit represented by the general formula (23) below is preferable.

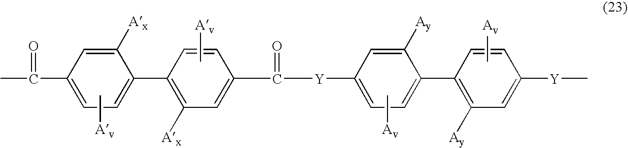

In the formula (23), A, A and Y are those defined by the formula (22), and v is an integer from 0 to 3, preferably is an integer from 0 to 2. Although each of x and y is 0 or 1, not both of them are 0.

Next, a laminated retardation plate of the present invention can be manufactured in the following manner.

First, an optically anisotropic layer (A) made of a polymer is prepared. As mentioned above, this optically anisotropic layer (A) is not limited particularly as long as it has an in-plane retardation [Re(A)] of 20 to 300 nm and a ratio [Rth(A)/Re(A)] between a thickness direction retardation [Re(A)] and the in-plane retardation [Re(A)] of 1.0 or more. Such a polymer film can be an unstretched film or a stretched film as mentioned above. For example, it can be obtained by stretching a polymer film that is formed by extrusion or flow-expanding. The stretched film can be a uniaxially stretched film or a biaxially stretched film.

Similarly, the stretching method is not limited particularly, and, for example, conventionally known stretching methods such as uniaxial stretching like a roll longitudinal stretching and biaxial stretching like tenter traverse stretching can be used. The roll longitudinal stretching can be performed using a heating roll, or performed in an atmosphere under a heated condition. Alternatively, these methods can be used together. The biaxial stretching can be selected from simultaneous biaxial stretching that uses tenters alone, and a sequential biaxial stretching that uses rolls and tenters. The stretch ratio is not limited particularly, but, for example, it can be determined suitably depending on the stretching method, the materials and the like. For the characteristics, preferably, the optically anisotropic layer (A), has excellent surface smoothness, uniformity in the birefringence, transparency, and heat resistance.

The polymer film before stretching is generally from 10 to 800 μm, and preferably, 10 to 700 μm. And, the thickness of the polymer film after stretching, i.e., the optically anisotropic layer (A) has the above-mentioned thickness.

On the other hand, the optically anisotropic layer (B) is not limited particularly as long as the in-plane retardation [Re(B)] is 3 nm or more and the ratio [Rth(B)/Re(B)] between the thickness direction retardation and the in-plane retardation is 1.0 or more. For example, it can be prepared in the following manner.

The optically anisotropic layer (B) can be formed on the substrate, for example, by forming a film by coating on the substrate the non-liquid crystalline polymer, and by solidifying the non-liquid crystalline polymer in the coated film. The non-liquid crystalline polymer such as polyimide inherently shows an optical property of ‘nx>nz’, ‘ny>nz’(nx≈ny>nz) regardless of alignment of the substrate. Thereby, an optically anisotropic layer showing an optical uniaxiality, i.e., retardation only in the thickness direction, can be formed. The optically anisotropic layer (B) can be used in a state separated from the base, or it can be used in a state formed on the base.

At this time, preferably, the optically anisotropic layer (A) is used for the base. When this optically anisotropic layer (A) is used for a base on which the non-liquid crystalline polymer is coated directly, lamination of the optically anisotropic layers (A) and (B) by using a pressure-sensitive adhesive or an adhesive will not be required, thereby the number of layers to be laminated can be decreased for further decreasing the thickness of the laminate.

As mentioned above, since the non-liquid crystalline polymer has a characteristic of showing an optical uniaxiality, it does not require alignment of the base. Therefore, both an alignment substrate and a non-alignment substrate can be used for the base. Furthermore, for example, the base can have retardation caused by birefringence, or the base can be free from such retardation caused by birefringence. The transparent substrate generating retardation due to the birefringence can be, for example, a stretched film or the like, and such a film can have birefringence controlled in the thickness direction. The birefringence can be controlled, for example, by a method of adhering a polymer film with a heat-shrinkable film, and further heating and stretching.

Though there is no specific limitation on a method of coating the non-liquid crystalline polymer on the base, examples thereof include a method of melting the non-liquid crystalline polymer with heat and then coating, or a method of preparing a polymer solution by dissolving the non-liquid crystalline polymer in a solvent and coating. The method of coating a polymer solution is preferred particularly because of the excellent operability.

The polymer concentration in the polymer solution is not limited particularly, but for example, the non-liquid crystalline polymer is preferably in a range of 5 to 50 weight parts, and more preferably 10 to 40 weight parts with regard to a solvent of 100 weight parts, thereby providing a viscosity for facilitating the coating.

The solvent of the polymer solution is not particularly limited as long as it can dissolve the materials such as the non-liquid crystalline polymer, and it can be selected suitably according to a kind of the polymer. Specific examples thereof include halogenated hydrocarbons such as chloroform, dichloromethane, carbon tetrachloride, dichloroethane, tetrachloroethane, trichloroethylene, tetrachloroethylene, chlorobenzene and orthodichlorobenzene; phenols such as phenol and parachlorophenol; aromatic hydrocarbons such as benzene, toluene, xylene, methoxybenzene and 1,2-dimethoxybenzene; ketone-based solvents such as acetone, methyl ethyl ketone, methyl isobutyl ketone, cyclohexanone, cyclopentanone, 2-pyrrolidone and N-methyl-2-pyrrolidone; ester-based solvents such as ethyl acetate and butyl acetate; alcohol-based solvents such as t-butyl alcohol, glycerin, ethylene glycol triethylene glycol, ethylene glycol monomethyl ether, diethylene glycol dimethyl ether, propylene glycol, dipropylene glycol and 2-methyl-2,4-pentanediol; amide-based solvents such as dimethylformamide and dimethylacetamide; nitrile-based solvents such as acetonitrile and butyronitrile; ether-based solvents such as diethyl ether, dibutyl ether and tetrahydrofuran; or carbon disulfide, ethyl cellosolve or butyl cellosolve. These solvents may be used alone or in combination of two or more.

In the polymer solution, various additives such as a stabilizer, a plasticizer, metal and the like further may be blended as necessary.

Moreover, the polymer solution may contain other resins as long as the alignment or the like of the material does not drop considerably. Such resins can be, for example, resins for general purpose use, engineering plastics, thermoplastic resins and thermosetting resins.

The resins for general purpose use can be, for example, polyethylene (PE), polypropylene (PP), polystyrene (PS), polymethyl methacrylate (PMMA), an ABS resin, an AS resin or the like. The engineering plastics can be, for example, polyacetate (POM), polycarbonate (PC), polyamide (PA: nylon), polyethylene terephthalate (PET), polybutylene terephthalate (PBT) or the like. The thermoplastic resins can be, for example, polyphenylene sulfide (PPS), polyethersulfone (PES), polyketone (PK), polyimide (PI), polycyclohexanedimethanol terephthalate (PCT), polyarylate (PAR), liquid crystal polymers (LCP) or the like. The thermosetting resins can be, for example, epoxy resins, phenolic novolac resins or the like.

When the above-described other resins are blended in the polymer solution as mentioned above, the blend amount ranges, for example, from 0 wt % to 50 wt %, preferably from 0 wt % to 30 wt %, with respect to the polymer.

The method of coating the polymer solution is selected, for example, from spin coating, roller coating, flow coating, printing, dip coating, flow-expanding, bar coating and gravure printing. In the coating, a method of superimposing polymer layers can be used as required.

The non-liquid crystalline polymer for forming the coating film can be solidified, for example, by drying the coating film. A drying method is not particularly limited but can be air drying or heat drying, for example. The conditions therefor can be determined suitably according to, for example, kinds of the non-liquid crystalline polymer and the solvent. For instance, the temperature therefor usually is 40° C. to 300° C., preferably is 50° C. to 250° C., and further preferably is 60° C. to 200° C. The coated surface may be dried at a constant temperature or by gradually rising or lowering the temperature. The drying time also is not particularly limited but usually is 10 seconds to 30 minutes, preferably 30 seconds to 25 minutes, and further preferably 1 minute to 20 minutes.

Since the solvent of the polymer solution remaining in the optically anisotropic layer (B) may change the optical properties of the laminated retardation plate over time, in proportion to the amount, the amount of the solvent is preferably, for example, 5% or less, more preferably, 2% or less, and further preferably, 0.2% or less.

Furthermore, an optically anisotropic layer (B) showing an optical biaxiality, i.e., ‘nx>ny>nz’, can be prepared by using a base that shows a shrinkage characteristic in one direction within a plane. Specifically, for example, the non-liquid crystalline polymer is coated directly on the base having a shrinkage characteristic so as to form a coating film as in the above-mentioned manner, and then, the base is shrunk. Since the coating film on the base is shrunk in the plane direction with the shrinkage of the base, the coating film will have a difference in the refraction within the plane, thus showing an optical biaxiality (nx>ny>nz). Then, the non-liquid crystalline polymer forming the coating film is solidified so as to form the biaxial optically anisotropic layer (B).

It is preferable that the base is stretched previously in one direction within the plane in order to provide a shrinkage characteristic in one direction within the plane. By previously stretching as mentioned above, a shrinkage force is generated in a direction opposite to the stretching direction. This difference in the in-plane shrinkage of the base is used for providing a difference in the refraction within the plane to the non-liquid crystalline polymer of the coating film. Though there is no specific limitation, the base before stretching has a thickness in a range, for example, from 10 to 200 μm, preferably from 20 to 150 μm, and particularly preferably from 30 to 100 μm. The stretch ratio is not limited particularly.

The base can be shrunk by heating after formation of a coating film on the base in the above-mentioned manner. Though the condition for the heating can be determined suitably depending on the kinds of the materials or the like without any particular limitations, for example, the temperature for heating is in a range of 25° C. to 300° C., preferably, 50° C. to 200° C., and particularly preferably, 60° C. to 180° C. Though there is no specific limitation on the shrinkage degree, for example, the shrinking ratio is higher than 0 and not higher than 10% when the length of the base before shrinking is 100%.

Alternatively, it is also possible to form an optically anisotropic layer (B) showing an optical biaxiality, i.e., ‘nx>ny>nz’, on a base, by forming a coating film on a base as mentioned above and stretching the transparent substrate and the coating film together. According to this method, by stretching together a laminate of the base and the coating film in one direction within the plane, the coating film will have further a refraction difference within the plane, thus showing the optical.

There is no specific limitation on the method of stretching a laminate of the base and the coating film. Examples of the stretching methods include stretching the film uniaxially in the longitudinal direction (free-end longitudinal stretching), stretching the film uniaxially in the transverse direction while the film is fixed in the longitudinal direction (fixed-end transverse stretching), and stretching the film both in the longitudinal and transverse directions (sequential or simultaneous biaxial.

Though the laminate can be stretched by pulling both the base and the coating film together, it is preferable that the base is stretched alone due to the following reason. When the base is stretched alone, the coating film on the base is stretched indirectly due to a tensile force generated in the base as a result of the stretching. Since typically a monolayer can be stretched more uniformly when compared to a case of stretching a laminate, the coating film on the base can be stretched uniformly as a result of stretching the transparent substrate alone as mentioned above.

Conditions for the stretching can be determined suitably depending on, for example, the kinds of the base and the non-liquid crystalline polymer and the like without any particular limitations. Though the temperature during the stretching is selected suitably corresponding to the kinds of the base and the non-liquid crystalline polymer, the glass transition points (Tg), the kinds of additives or the like. For example, the temperature range is from 80° C. to 250° C., preferably from 120° C. to 220° C., and particularly preferably from 140° C. to 200° C. Especially, the temperature is preferably substantially equal to or higher than Tg of base material.

By laminating the thus obtained optically anisotropic layer (A) and the optically anisotropic layer (B) via, for example, a pressure-sensitive adhesive or an adhesive, the laminated retardation plate of the present invention can be formed. Alternatively, it is possible to adhere the optically anisotropic layer (B) formed on a base (first base) to the optically anisotropic layer (A) via a pressure-sensitive adhesive or the like, from which the first base will be peeled off.

There is no specific limitation on the adhesive and the pressure-sensitive adhesive, and conventionally known transparent adhesives and pressure-sensitive adhesives based on, for example, acrylic substances, silicone, polyester, polyurethane, polyether and rubbers, can be used. Among them, particularly preferred materials do not require a high temperature process for curing or drying, from the aspects of preventing changes in the optical properties of the laminated retardation material. Specifically, an acrylic pressure-sensitive adhesive, which does not require a long time curing process or time for drying, is preferred. The adhesion method is not limited to the above description, but it is also possible, as mentioned above, that the laminated retardation plate of the present invention is formed by using the optically anisotropic layer (A) as a base for forming the optically anisotropic layer (B), and by forming directly thereon the optically anisotropic layer (B). In this embodiment, for example, since the pressure-sensitive adhesive layers and/or the adhesive layers can be omitted, the number of layers to be laminated can be decreased for further decreasing the thickness. Alternatively, it is also possible to use the optically anisotropic layer (A) as the base, on which the optically anisotropic layer (B) is laminated directly as mentioned above, and the thus obtained laminate can be stretched further as mentioned above, and/or the optically anisotropic layer (A) is shrunk so that the optically anisotropic layer (B) is also shrunk.

Moreover, it is preferable that the laminated retardation plate of the present invention further has a pressure-sensitive adhesive layer or an adhesive layer on the outermost layer. The adhesive layer or the pressure-sensitive adhesive layer facilitates adhesion of the laminated retardation plate of the present invention to the other optical layers or the other members such as a liquid crystal cell and also prevents peeling of the laminated retardation plate of the present invention. The pressure-sensitive adhesive layer can be one of the outermost layers of the laminated retardation plate, or it can be laminated on both the outermost layers.

The material for the pressure-sensitive adhesive layer is not particularly limited but can be a conventionally known material such as acrylic polymers. Further, a pressure-sensitive adhesive layer having a low moisture absorption coefficient and an excellent heat resistance is preferable from the aspects of prevention of foaming or peeling caused by moisture absorption, prevention of degradation in the optical properties and warping of a liquid crystal cell caused by difference in thermal expansion coefficients, and formation of an image display device with high quality and excellent durability. It also may be possible to incorporate fine particles into a pressure-sensitive adhesive so as to form the pressure-sensitive adhesive layer showing light diffusion property. For the purpose of forming the pressure-sensitive adhesive layer on the surface of the laminated retardation plate, for example, a solution or melt of a sticking material can be applied directly on a predetermined surface of the polarizing plate by a development method such as flow-expansion and coating. Alternatively, a pressure-sensitive adhesive layer can be formed on a liner, which will be described below, in the same manner and transferred to a predetermined surface of the laminated retardation plate.

In the case where a surface of the pressure-sensitive adhesive layer arranged on the laminated retardation plate is exposed, it is preferable to cover the surface with a liner. This makes it possible to prevent the pressure-sensitive adhesive layer from being contaminated until the pressure-sensitive adhesive layer is used. The liner can be formed by, for example, providing a suitable film such as the above-mentioned transparent film with a release coat such as a silicone-based release agent, a long-chain alkyl-based release agent, a fluorocarbon release agent or a molybdenum sulfide release agent, as necessary.

The pressure-sensitive adhesive layer can be a monolayer or a laminate. The laminate can include monolayers different from each other in the type or in the compositions. When arranged on both surfaces of the polarizing plate, the pressure-sensitive adhesive layers can be the same or can be different from each other in types or compositions.

The thickness of the pressure-sensitive adhesive layer can be determined suitably depending on the constituents or the like of the polarizing plate. In general it is from 1 to 500 μm.

It is preferable that the pressure-sensitive adhesive layer is made of a pressure-sensitive adhesive having excellent optical transparency and appropriate characteristics such as wettability, cohesiveness, and adhesiveness. The pressure-sensitive adhesive can be prepared appropriately based on polymers such as an acrylic polymer, a silicone-based polymer, polyester, polyurethane, polyether, and synthetic rubber.

Adhesiveness of the pressure-sensitive adhesive layer can be controlled suitably by a conventionally known method. For example, the degree of cross-linkage and the molecular weight will be adjusted on the basis of a composition or molecular weight of the base polymer for forming the pressure-sensitive adhesive, a cross-linking method, a content ratio of the crosslinkable functional group, and a ratio of the blended crosslinking agent.

The laminated retardation plate of the present invention can be used alone as mentioned above, or it can be combined with any other optical member(s) as required to form a laminate to be used for various optical applications. Specifically, it is useful as an optical compensating member. Though there is no specific limitation, the optical member(s) can be, for examples, the below mentioned polarizer or the like.

A laminated polarizing plate of the present invention is a laminated polarizing plate including an optical film and a polarizer, where the optical film is the laminated retardation plate of the present invention.

Though there is no specific limitation on the configuration of the polarizing plate as long as it has the laminated retardation plate of the present invention, examples thereof are as follows. The polarizing plate of the present invention is not limited to the following configuration as long as it has the laminated retardation plate of the present invention and a polarizer, but it can further include an additional optical member or the like. Alternatively, any additional component(s) can be omitted.

An example of the laminated polarizing plate of the present invention has, for example, the laminated retardation plate of the present invention, a polarizer and two transparent protective layers, wherein the transparent protective layers are laminated on both surfaces of the polarizer via adhesive layers, and the laminated retardation plate is laminated further on one of the transparent protective layers via an adhesive layer. Regarding the laminated retardation plate, which is a laminate of an optically anisotropic layer (A) and an optically anisotropic layer (B) as mentioned above, any surface can face the transparent protective layer side.

The transparent protective layer can be laminated on both surfaces of the polarizers as mentioned above, or it can be laminated only on one surface thereof. In the case where the transparent protective layer is arranged on both surfaces of the polarizer, the layers may be the same or different. Though there is no specific limitation on the method of adhering the respective layers, a pressure-sensitive adhesive or an adhesive can be used for the adhesive layer, and furthermore, such an adhesive layer can be omitted when the layers can be laminated directly.

Another example of the laminated polarizing plate has the laminated retardation plate of the present invention, a polarizer and a transparent protective layer, wherein the transparent protective layer is laminated on one surface of the polarizer via an adhesive layer, and the laminated retardation plate is laminated on the other surface of the polarizer via an adhesive layer.

Since the laminated retardation plate is a laminate formed by laminating an optically anisotropic layer (A) and an optically anisotropic layer (B) via adhesive layers, any of the surfaces can face the polarizer side. However, for example, it is preferable that the laminated retardation plate is arranged so that the optically anisotropic layer (A) will face the polarizer side. According to this configuration, the optically anisotropic layer (A) of the present invention can be used also for a transparent protective layer in the laminated polarizing plate. That is, instead of laminating transparent protective layers on both surfaces of the polarizer, a transparent protective layer is laminated on one surface of the polarizer while the laminated retardation plate is laminated on the other surface so that the optically anisotropic layer (A) will face the polarizer side, thereby the optically anisotropic layer (A) will function also as a transparent protective layer on the polarizer. The thus obtained polarizing plate can have a further decreased thickness.

The polarizing film is not particularly limited but can be a film prepared by a conventionally known method of, for example, dyeing by allowing a film of various kinds to adsorb a dichroic material such as iodine or a dichroic dye, followed by cross-linking, stretching and drying. Especially, films that transmit linearly polarized light when natural light is made to enter those films are preferable, and films having excellent light transmittance and polarization degree are preferable. Examples of the film of various kinds in which the dichroic material is to be adsorbed include hydrophilic polymer films such as polyvinyl alcohol (PVA)-based films, partially-formalized PVA-based films, partially-saponified films based on ethylene-vinyl acetate copolymer and cellulose-based films. Other than the above, polyene oriented films such as dehydrated PVA and dehydrochlorinated polyvinyl chloride can be used, for example. Among them, the PVA-based film is preferable. In addition, the thickness of the polarizing film generally ranges from 1 to 80 μm, though it is not limited to this.

The protective layer is not particularly limited but can be a conventionally known transparent film. For example, transparent protective films having excellent transparency, mechanical strength, thermal stability, moisture shielding property and isotropism are preferable. Specific examples of materials for such a transparent protective layer can include cellulose-based resins such as triacetylcellulose, and transparent resins based on polyester, polycarbonate, polyamide, polyimide, polyethersulfone, polysulfone, polystyrene, polynorbornene, polyolefin, acrylic substances, acetate and the like. Thermosetting resins or ultraviolet-curing resins based on the acrylic substances, urethane, acrylic urethane, epoxy, silicones and the like can be used as well. Among them, a TAC film having a surface saponified with alkali or the like is preferable in view of the polarization property and durability.

Moreover, the polymer film described in JP 2001-343529A (WO 01/37007) also can be used. The polymer material used can be a resin composition containing a thermoplastic resin whose side chain has a substituted or unsubtituted imido group and a thermoplastic resin whose side chain has a substituted or unsubtituted phenyl group and nitrile group, for example, a resin composition containing an alternating copolymer of isobutene and N-methylene maleimide and an acrylonitrile-styrene copolymer. Alternatively, the polymer film may be formed by extruding the resin composition.

It is preferable that the protective layer is colorless. More specifically, a retardation value (Rth) of the film in its thickness direction as represented by the equation below preferably ranges from −90 nm to +75 nm, more preferably ranges from −0 nm to +60 nm, and particularly preferably ranges from −70 nm to +45 nm. When the retardation value is within the range of −90 nm to +75 nm, coloration (optical coloration) of the polarizing plate, which is caused by the protective film, can be solved sufficiently. In the equation below, nx, ny and nz are similar to those described above, and d indicates the film thickness.
Rth=[{(nx+ny)/2}−nz]·d

The transparent protective layer further may have an optically compensating function. As such a transparent protective layer having the optically compensating function, it is possible to use, for example, a known layer used for preventing coloration caused by changes in a visible angle based on retardation in a liquid crystal cell or for widening a preferable viewing angle. Specific examples include various films obtained by stretching the above-described transparent resins uniaxially or biaxially, an oriented film of a liquid crystal polymer or the like, and a laminate obtained by providing an oriented layer of a liquid crystal polymer on a transparent base. Among the above, the oriented film of a liquid crystal polymer is preferable because a wide viewing angle with excellent visibility can be achieved. Particularly preferable is an optically compensating retardation plate obtained by supporting an optically compensating layer with the above-mentioned triacetylcellulose film or the like, where the optically compensating layer is made of an incline-oriented layer of a discotic or nematic liquid crystal polymer. This optically compensating retardation plate can be a commercially available product, for example, “WV film” manufactured by Fuji Photo Film Co., Ltd. Alternatively, the optically compensating retardation plate can be prepared by laminating two or more layers of the retardation film and the film support of triacetylcellulose film or the like so as to control the optical properties such as retardation.

The thickness of the transparent protective layer is not particularly limited but can be determined suitably according to retardation or protection strength, for example. In general, the thickness is in the range not greater than 500 μm, preferably from 1 to 300 μm, and more preferably from 5 to 150 μm.

The transparent protective layer can be formed suitably by a conventionally known method such as a method of coating a polarizing film with the above-mentioned various transparent resins or a method of laminating the transparent resin film, the optically compensating retardation plate or the like on the polarizing film, or can be a commercially available product.

The transparent protective layer further may be subjected to, for example, a hard coating treatment, an antireflection treatment, treatments for anti-sticking, diffusion and anti-glaring and the like. The hard coating treatment aims at preventing scratches on the surfaces of the polarizing plate, and is a treatment of; for example, providing a hardened coating film that is formed of a curable resin and has excellent hardness and smoothness onto a surface of the transparent protective layer. The curable resin can be, for example, ultraviolet-curing resins of silicone base, urethane base, acrylic, and epoxy base. The treatment can be carried out by a conventionally known method. The anti-ticking treatment aims at preventing adjacent layers from sticking to each other. The antireflection treatment aims at preventing reflection of external light on the surface of the polarizing plate, and can be carried out by forming a conventionally known antireflection layer or the like.

The anti-glare treatment aims at preventing reflection of external light on the polarizing plate surface from hindering visibility of light transmitted through the polarizing plate. The anti-glare treatment can be carried out, for example, by providing microscopic asperities on a surface of the transparent protective layer by a conventionally known method. Such microscopic asperities can be provided, for example, by roughening the surface by sand-blasting or embossing, or by blending transparent fine particles in the above-described transparent resin when forming the transparent protective layer.

The above-described transparent fine particles may be silica, alumina, titania, zirconia, stannic oxide, indium oxide, cadmium oxide, antimony oxide or the like. Other than the above, inorganic fine particles having an electrical conductivity or organic fine particles comprising, for example, crosslinked or uncrosslinked polymer particles can be used as well. The average particle diameter of the transparent fine particles ranges, for example, from 0.5 to 20 μm, though there is no specific limitation. In general, a blend ratio of the transparent fine particles preferably ranges from 2 to 70 parts by weight, and more preferably ranges from 5 to 50 parts by weight with respect to 100 parts by weight of the above-described transparent resin, though there is no specific limitation.

The anti-glare layer in which the transparent fine particles are blended can be used as the transparent protective layer itself or provided as a coating layer coated onto the transparent protective layer surface. Furthermore, the anti-glare layer also can function as a diffusion layer to diffuse light transmitted through the polarizing plate in order to widen the viewing angle (i.e., visually-compensating function).

The antireflection layer, the anti-sticking layer, the diffusion layer and the anti-glare layer mentioned above can be laminated on the polarizing plate, as a sheet of optical layers comprising these layers, separately from the transparent protective layer.

Lamination of the respective components (e.g., the optically anisotropic layer (A), the optically anisotropic layer (B), the laminated retardation plate, the polarizers and the transparent protective layer(s)) can be carried out by a conventionally known method, without any particular limitations. In general, a pressure-sensitive adhesive, an adhesive and the like as described above can be used, and the adhesive or the pressure-sensitive adhesive can be selected appropriately, depending on the kinds or the like of the respective components. The adhesive can be selected from polymeric adhesives based on acrylic substances, vinyl alcohol, silicone, polyester, polyurethane, polyether or the like, and rubber-based adhesives. These pressure-sensitive adhesives and adhesives are difficult to peel off even under an influence of humidity or heat, and they are excellent in optical transparency and polarization degree. Specifically, a PVA-based adhesive is preferably used for a polarizer of a PVA-based film in view of its adhesion stability or the like. Such an adhesive or a pressure-sensitive adhesive can be applied directly to the surface of a polarizer or a transparent protective layer. Alternatively, a layer of the adhesive or the pressure-sensitive adhesive formed as a tape or a sheet can be arranged on the surface. When an adhesive or a pressure-sensitive adhesive is prepared as an aqueous solution, other additive(s) or catalyst(s) such as acid(s) can be blended as required. In coating the adhesive, an additive or a catalyst such as an acid can be blended into the aqueous solution of the adhesive. Though the thickness of the adhesive layer is not limited particularly, for example, it ranges from 1 nm to 500 nm, preferably from 10 nm to 300 nm, and more preferably from 20 nm to 100 nm. Any conventionally known methods for using adhesives such as acrylic polymers or vinyl alcohol-based polymers can be used without any particular limitations. Alternatively, the adhesive can contain a water-soluble crosslinking agents of PVA-based polymers, such as glutaraldehyde, melamine and oxalic acid. These adhesives are difficult to peel off even under an influence of humidity or heat, and they are excellent in optical transparency and polarization degree. For example, these adhesives can be coated as aqueous solutions on the surfaces of the respective components and dried before use. In the aqueous solution, for example, other additive(s) and catalyst(s) such as acids can be blended as required. Among them, for the adhesive, a PVA-based adhesive is preferred in light of the excellent adhesiveness to the PVA film.

The laminated retardation plate of the present invention can be used in combination with a conventionally known optical member, for example, various retardation plates, diffusion-control films, and brightness-enhancement films, other than the above-mentioned polarizer. A retardation film can be prepared by, for example, stretching a polymer uniaxially or biaxially, subjecting a polymer to Z-axis alignment, or coating a liquid crystal polymer on a base. The diffusion-control films can use diffusion, scattering, and refraction for controlling viewing angles, or for controlling glaring and scattered light that will affect definition. The brightness-enhancement film may include a quarter wavelength plate (λ/4 plate) and a selective reflector of a cholesteric liquid crystal, and a scattering film using an anisotropic scatter depending on the polarization direction. Also, the optical film can be combined with a wire grid polarizer, for example.

The laminated polarizing plate according to the present invention can include in use an additional optical layer together with the laminated retardation plate of the present invention and a polarizer. Examples of the optical layers include various optical layers that have been conventionally known and used for forming liquid crystal displays or the like, such as a polarizing plate, a reflector, a semitransparent reflector, and a brightness-enhancement film as mentioned below. These optical layers can be used alone or in combination of at least two kinds of layers. Such an optical layer can be provided as a single layer, or at least two optical layers can be laminated. A laminated polarizing plate further including such an optical layer is used preferably as an integrated polarizing plate having an optical compensation function, and it can be arranged on a surface of a liquid crystal cell, for example, so as to be used suitably for various image displays.

The integrated polarizing plate will be described below.

First, an example of a reflective polarizing plate or a semitransparent reflective polarizing plate will be described. The reflective polarizing plate is prepared by laminating further a reflector on a polarizing plate with optical compensation function according to the present invention, and the semitransparent reflective polarizing plate is prepared by laminating a semitransparent reflector on a polarizing plate with optical compensation function according to the present invention.

In general, such a reflective polarizing plate is arranged on a backside of a liquid crystal cell in order to make a liquid crystal display (reflective liquid crystal display) to reflect incident light from a visible side (display side). The reflective polarizing plate has some merits, for example, assembling of light sources such as a backlight can be omitted, and the liquid crystal display can be thinned further.

The reflective polarizing plate can be formed in any known manner such as forming a reflector of metal or the like on one surface of a polarizing plate having a certain elastic modulus. More specifically, one example thereof is a reflective polarizing plate formed by matting one surface (surface to be exposed) of a transparent protective layer of the polarizing plate as required, and providing the surface with a deposited film or a metal foil comprising a reflective metal such as aluminum.

An additional example of a reflective polarizing plate is prepared by forming, on a transparent protective layer having a surface with microscopic asperities due to microparticles contained in various transparent resins, a reflector corresponding to the microscopic asperities. The reflector having a microscopic asperity surface diffuses incident light irregularly so that directivity and glare can be prevented and irregularity in color tones can be controlled. The reflector can be formed by attaching the metal foil or the metal deposited film directly on an asperity surface of the transparent protective layer in any conventional and appropriate methods including deposition such as vacuum deposition, and plating such as ion plating and sputtering.

As mentioned above, the reflector can be formed directly on a transparent protective layer of a polarizing plate. Alternatively, the reflector can be used as a reflecting sheet formed by providing a reflecting layer onto a proper film similar to the transparent protective film. Since a typical reflecting layer of a reflector is made of a metal, it is preferably used in a state such that the reflecting surface is coated with the film, a polarizing plate or the like in order to prevent a reduction of the reflection rate due to oxidation, furthermore, the initial reflection rate is maintained for a long period, and a separate formation of a transparent protective layer is avoided.

A semitransparent polarizing plate is provided by replacing the reflector in the above-mentioned reflective polarizing plate by a semitransparent reflector, and it is exemplified by a half-mirror that reflects and transmits light at the reflecting layer.

In general, such a semitransparent polarizing plate is arranged on a backside of a liquid crystal cell. In a liquid crystal display including the semitransparent polarizing plate, incident light from the visible side (display side) is reflected to display an image when a liquid crystal display is used in a relatively bright atmosphere, while in a relatively dark atmosphere, an image is displayed by using a built-in light source such as a backlight on the backside of the semitransparent polarizing plate. In other words, the semitransparent polarizing plate can be used to form a liquid crystal display that can save energy for a light source such as a backlight under a bright atmosphere, while a built-in light source can be used under a relatively dark atmosphere.

The following description is about an example of a laminated polarizing plate prepared by further laminating a brightness-enhancement film on a polarizing plate with optical compensation function according to the present invention.

A suitable example of the brightness-enhancement film is not particularly limited, but it can be selected from a multilayer thin film of a dielectric or a multilayer lamination of thin films with varied refraction aeolotropy (for example, trade name: “D-BEF” manufactured by 3M Co.) that transmits linearly polarized light having a predetermined polarization axis while reflecting other light, and a cholesteric liquid crystal layer, more specifically, an aligned film of a cholesteric liquid crystal polymer or an aligned liquid crystal layer fixed onto a supportive film substrate (for example, trade name: “PCF 350” manufactured by Nitto Denko Corporation; trade name: “Transmax” manufactured by Merck and Co., Inc.) that reflects either clockwise or counterclockwise circularly polarized light while transmitting other light.

The above-mentioned various polarizing plates of the present invention can be, for example, an optical member on which an additional optical layer is laminated further.

An optical member including a laminate of at least two optical layers can be formed, for example, by a method of laminating layers separately in a certain order for manufacturing a liquid crystal display or the like. However, since an optical member that has been laminated previously has excellent stability in quality and assembling operability, efficiency in manufacturing a liquid crystal display can be improved. Any appropriate adhesives such as a pressure-sensitive adhesive layer can be used for lamination.

Moreover, it is preferable that the various polarizing plates according to the present invention further have a pressure-sensitive adhesive layer or an adhesive layer so as to allow easier lamination onto the other members such as a liquid crystal cell. These adhesive layers can be arranged on one surface or both surfaces of the polarizing plate. The material of the pressure-sensitive adhesive layer is not particularly limited but can be a conventionally known material such as acrylic polymers. Further, the pressure-sensitive adhesive layer having a low moisture absorption coefficient and an excellent thermal resistance is preferable from the aspects of prevention of foaming or peeling caused by moisture absorption, prevention of degradation in the optical properties and warping of a liquid crystal cell caused by difference in thermal expansion coefficients, and formation of an image display apparatus with high quality and excellent durability. It is also possible to incorporate fine particles so as to form the pressure-sensitive adhesive layer showing light diffusion property. For the purpose of forming the pressure-sensitive adhesive layer on the surface of the polarizing plate, a solution or melt of a sticking material can be applied directly on a predetermined surface of the polarizing plate by a development method such as flow-expansion and coating. Alternatively, a pressure-sensitive adhesive layer can be formed on a separator, which will be described below, in the same manner and transferred to a predetermined surface of the polarizing plate. Such a layer can be formed on any surface of the polarizing plate. For example, it can be formed on an exposed surface of the optically compensation layer of the polarizing plate.

When a surface of a layer of an adhesive or a pressure-sensitive adhesive provided on the polarizing plate is exposed, preferably, the pressure-sensitive adhesive layer is covered with a separator until the time the pressure-sensitive adhesive layer is used so that contamination will be prevented. The separator can be formed by coating, on a proper film such as the transparent protective film, a peeling layer including a peeling agent containing silicone, long-chain alkyl, fluorine, molybdenum sulfide or the like as required.

The pressure-sensitive adhesive layer or the like can be a monolayer or a laminate. The laminate can be a combination of monolayers different from each other in the type or in the compositions. Pressure-sensitive adhesive layers arranged on both surfaces of the polarizing plate can be the same or different from each other in the type or in the compositions.

The thickness of the pressure-sensitive adhesive layer can be determined appropriately depending on the constituents or the like of the polarizing plate. In general, the thickness of the pressure-sensitive adhesive layer is 1 μm to 500 μm.

It is preferable that the pressure-sensitive adhesive layer is made of a pressure-sensitive adhesive having excellent optical transparency and sticking characteristics such as wettability, cohesiveness, and adhesiveness. For specific example, the pressure-sensitive adhesive can be prepared appropriately based on polymers such as an acrylic polymer, a silicone-based polymer, polyester, polyurethane, polyether, and synthetic rubber.

Sticking characteristics of the pressure-sensitive adhesive layer can be controlled appropriately in a known method. For example, the degree of cross-linkage and the molecular weight will be adjusted on the basis of a composition or molecular weight of the base polymer of the pressure-sensitive adhesive layer, crosslinking type, a content of the crosslinking functional group, and an amount of the blended crosslinking agent.

The laminated retardation plate and the laminated polarizing plate of the present invention, and the respective members composing these plates (e.g., an optically anisotropic layer (A), an optically anisotropic layer (B), a polarizer, a transparent protective layer, an optical layer and a pressure-sensitive adhesive layer) can have ultraviolet absorption power as a result of treatment with an ultraviolet absorber such as a salicylate compound, a benzophenone compound, a benzotriazole compound, a cyanoacrylate compound, and a nickel complex salt compound.

As mentioned above, laminated retardation plate and the laminated polarizing plate of the present invention can be used preferably for forming various devices such as liquid crystal displays. For example, a laminated retardation plate or a laminated polarizing plate of the present invention is arranged on at least one surface of a liquid crystal cell in order to form a liquid crystal panel used in a liquid crystal display of, e.g., a transmission type, a reflection type, or a transmission-reflection type.

A liquid crystal cell to compose the liquid crystal display can be selected from appropriate cells such as active matrix driving type represented by a thin film transistor, a simple matrix driving type represented by a twist nematic type and a super-twist nematic type. Since the polarizing plates with optical compensation function according to the present invention are excellent particularly in optical compensation of a VA (Vertical Aligned) cell, they are used particularly preferably for viewing-angle compensating films for VA mode liquid crystal displays.

In general, a typical liquid crystal cell is composed of opposing liquid crystal cell substrates and a liquid crystal injected into a space between the substrates. The liquid crystal cell substrates can be made of glass, plastics or the like without any particular limitations. Materials for the plastic substrates can be selected from conventionally known materials without any particular limitations.

When polarizing plates or optical members are arranged on both surfaces of a liquid crystal panel, the laminated retardation plate or the laminated polarizing plate of the present invention can be arranged on at least one surface, and the laminated retardation plate or the laminated polarizing plate can be the same or different type. Moreover, for forming a liquid crystal display, one or more layers of appropriate members such as a prism array sheet, a lens array sheet, an optical diffuser and a backlight can be arranged at proper positions.

The liquid crystal display according to the present invention is not particularly limited as long as it includes a liquid crystal panel and the liquid crystal panel of the present invention is used therefor. When it includes a light source, preferably, the light source is a flat light source emitting polarized light for enabling effective use of light energy, though there is no particular limitation.

A liquid crystal panel according to the present invention include, for example, a liquid crystal cell, a laminated retardation plate of the present invention, a polarizer and a transparent protective layer, wherein the laminated retardation plate is laminated on one surface of the liquid crystal cell, and the polarizer and the transparent protective layer are laminated on the other surface of the laminated retardation plate in this order. The liquid crystal cell has a configuration where a liquid crystal is interposed between two liquid crystal cell substrates. The laminated retardation plate is a laminate of the optically anisotropic layer (A) and the optically anisotropic layer (B) as mentioned above, and either surface can face the polarizer side.

The liquid crystal display of the present invention can include additional member(s) on the visible side optical film (laminated polarizing plate). The member can be selected from, for example, a diffusion plate, an anti-glare layer, an antireflection film, a protective layer, and a protective plate. Alternatively, a compensating retardation plate or the like can be disposed suitably between the liquid crystal cell and the polarizing plate in the liquid crystal panel.

The polarizing plate with optical compensation function according to the present invention can be used not only in the above-described liquid crystal display but also in, for example, self-light-emitting displays such as an organic electrolumiescence (EL) display, a PDP and a FED. When it is used in a self-light-emitting flat display, for example, the in-plane retardation values And of the laminated retardation plate and of the laminated polarizing plate of the present invention are set to λ/4 in order to obtain circularly polarized light, and thus it can be used for an antireflection filter.

The following is a specific description of an electroluminescence (EL) display comprising a polarizing plate with optical compensation function according to the present invention. The EL display of the present invention is a display having the laminated retardation plate or the laminated polarizing plate of the present invention, and can be either an organic EL display or an inorganic EL display.

In recent EL displays, for preventing reflection from an electrode in a black state in an EL display, use of an optical film such as a polarizer and a polarizing plate as well as a λ/4 plate is proposed. The laminated retardation plate and the laminated polarizing plate of the present invention are especially useful when linearly polarized light, circularly polarized light or elliptically polarized light is emitted from an EL layer. The polarizing plate with optical compensation function according to the present invention is especially useful even when an oblique light beam is partially polarized even in the case where natural light is emitted in a front direction.

First, a typical organic EL display will be explained below. In general, such an organic EL display has a Ruminant (organic EL ruminant) that is prepared by laminating a transparent electrode, an organic luminant layer and a metal electrode in this order on a transparent substrate. Here, the organic ruminant layer is a laminate of various organic thin films. Examples thereof include various combinations such as a laminate of a hole injection layer made of a triphenylamine derivative or the like and a luminant layer made of a phosphorous organic solid such as anthracene; a laminate of the ruminant layer and an electron injection layer made of a perylene derivative or the like; and a laminate of the hole injection layer, the ruminant layer and the electron injection layer.

In general, the organic EL display emits light according to the following principle: a voltage is applied to the anode and the cathode so as to inject holes and electrons into the organic ruminant layer, energy generated by the re-bonding of these holes and electrons excites the phosphor, and the excited phosphor emits light when it returns to the basis state. The mechanism of the re-bonding of these holes and electrons during the process is similar to that of an ordinary diode. This implies that current and the light emitting intensity show a considerable nonlinearity accompanied with a rectification with respect to the applied voltage.

It is preferred for the organic EL display that at least one of the electrodes is transparent so as to obtain luminescence at the organic luminant layer. In general, a transparent electrode of a transparent conductive material such as indium tin oxide (ITO) is used for the anode. Use of substances having small work function for the cathode is effective for facilitating the electron injection and thereby raising luminous efficiency, and in general, metal electrodes such as Mg—Ag and Al—Li can be used.

In an organic EL display configured as described above, it is preferable that the organic luminant layer usually is made of a film that is extremely thin such as about 10 nm, so that the organic ruminant layer can transmit substantially all light as the transparent electrode does. As a result, when the layer does not illuminate, a light beam entering from the surface of the transparent substrate and passing through the transparent electrode and the organic luminant layer before being reflected at the metal layer comes out again to the surface of the transparent substrate. Thereby, the display surface of the organic EL display looks like a mirror when viewed from exterior.

An organic EL display according to the present invention, which includes the organic EL ruminant, has, for example, a transparent electrode on the surface side of the organic ruminant layer, and a metal electrode on the backside of the organic luminant layer. In the organic El display, it is preferable that a laminated retardation plate or a laminated polarizing plate of the present invention is arranged on the surface of the transparent electrode, and furthermore, a λ/4 plate is arranged between the polarizing plate and an EL element. As described above, an organic EL display obtained by arranging a laminated retardation plate or a laminated polarizing plate of the present invention can suppress external reflection and improve the visibility. It is further preferable that a retardation plate is arranged between the transparent electrode and an optical film.

The retardation plate and the polarizing plate and the like polarize, for example, light which enters from outside and is reflected by the metal electrode, and thus the polarization has an effect that the mirror of the metal electrode cannot be viewed from the outside. Particularly, the mirror of the metal electrode can be blocked completely by forming the retardation plate with a quarter wavelength plate and adjusting an angle formed by the polarization directions of the retardation plate and the polarizing plate to be π/4. That is, the polarizing plate transmits only the linearly polarized light component among the external light entering the organic EL display. In general, the linearly polarized light is changed into elliptically polarized light by the retardation plate. When the retardation plate is a quarter wavelength plate and when the angle is π/4, the light is changed into circularly polarized light.

This circularly polarized light passes through, for example, the transparent substrate, the transparent electrode, and the organic thin film. After being reflected by the metal electrode, the light passes again through the organic thin film, the transparent electrode and the transparent substrate, and turns into linearly polarized light at the retardation plate. Moreover, since the linearly polarized light crosses the polarization direction of the polarizing plate at a right angle, it cannot pass through the polarizing plate. Consequently, as described above, the mirror of the metal electrode can be blocked completely.

### EXAMPLES

The following is a further description of the present invention, with reference to Examples and Comparative examples. It should be noted that the present invention is not limited to these Examples alone. The optical properties and the thickness were measured in the following manner.

(Measurement of Retardation Value)

The retardation value was measured using a retardation meter applying a parallel Nicol rotation method as a principle (manufactured by Oji Scientific Instruments, trade name: KOBRA21-ADH) (measurement wavelength: 610 nm).

(Film Thickness Measurement)

The thickness was measured with DIGITAL MICROMETER-K-351C (trade name) manufactured by Anritsu.

### Example A-1

A norbornene film having a thickness of 100 μm was subjected to a tenter transverse stretching at 175° C. The stretch ratio was 1.4 its pre-stretch length in the stretching direction. Thereby, an optically anisotropic layer (A) having a thickness of 69 μm, Re(A)=67 nm, and Rth(A)=136 nm, was obtained. Polyimide (weight average molecular weight: 59,000), which was synthesized from 2,2′-bis(3,4-dicarboxydiphenyl)hexafluoropropane) and 2,2′-bis(trifluromethyl)-4,4′-diamino biphenyl was dissolved in cyclohexanone, thereby a 15 wt % polyimide solution was prepared. After coating this polyimide solution on a biaxially stretched PET film, the coating film was dried (temperature: 150° C.; time: 5 minutes), thereby an optically anisotropic layer (B) having a thickness of 3 μm was formed on this stretched PET film. This optically anisotropic layer (B) had optical properties of Re(B)=3 nm, Rth(B)=110 nm, and Rth(B)/Re(B)=32.7. Then, after adhering the optically anisotropic layer (B) on the stretched PET film to the optically anisotropic layer (A) via an acrylic pressure-sensitive adhesive layer having a thickness of 15 μm, the stretched PET film was peeled to obtain a laminated retardation plate.

### Example A-2

A polyester film having a thickness of 70 μm was subjected to a longitudinal stretching at 160° C. The stretch ratio was 1.1 its pre-stretch length in the stretching direction. The thus obtained optically anisotropic layer (A) was 64 μm in thickness, Re(A)=65 nm, Rth(A)=70 nm, and Rth(A)/Re(A)=1.1. Next, on this optically anisotropic layer (A), a polyimide solution prepared as in Example A-1 was coated directly, and the coating film was dried (temperature: 150° C.; time: 5 minutes) so as to form an optically anisotropic layer (B) on the optically anisotropic layer (A), thereby producing a laminated retardation plate. The optically anisotropic layer (B) was 5 μm in thickness, and the optical properties were: Re(B)=5 nm, Rth(B)=180 nm, and Rth(B)/Re(B)=36.0. The optical properties of the optically anisotropic layer (B) were measured after peeling from the optically anisotropic layer (A).

### Example A-3

A polyimide solution prepared as in Example A-1 was coated on a triacetylcellulose (TAC) film having a thickness of 80 μm, and subjected to a tenter transverse stretching while being dried for 5 minutes at a temperature of 180° C. The stretch ratio was 2.0 its pre-stretch length in the stretching direction. As a result of this stretching, an optically anisotropic layer (B) made of polyimide was formed on the stretched TAC film (optically anisotropic layer (A)), thereby a laminated retardation plate was obtained. The optically anisotropic layer (A) was 67 μm in thickness, and the optical properties were: Re(A)=30 nm, Rth(A)=55 nm, and Rth(A)/Re(A)=1.8. The optically anisotropic layer (B) was 5 μm in thickness, and the optical properties were: Re(B)=40 nm, Rth(B)=198 nm, and Rth(B)/Re(B)=5.

### Example A-4

Polyimide (weight average molecular weight: 60,000), which was synthesized from 4,4′-bis(3,4-dicarboxyphenyl)-2,2-diphenylpropane dianhydride and 2,2′-dichloro-4,4′-diamino biphenyl was dissolved in cyclopentanone, thereby a 20 wt % polyimide solution was prepared. This polyimide solution was coated on a TAC film having a thickness of 80 μm, subjected to a tenter transverse stretching while being dried for 5 minutes at 180° C. The stretch ratio was 1.1 its pre-stretch length in the stretching direction. As a result of this stretching, an optically anisotropic layer (B) made of polyimide was formed on the stretched TAC film (optically anisotropic layer (A)), thereby a laminated retardation plate was obtained. The optically anisotropic layer (A) was 74 μm in thickness, and the optical properties were: Re(A)=25 nm, Rth(A)=50 nm, and Rth(A)/Re(A)=2. The optically anisotropic layer (B) was 6 μm in thickness, and the optical properties were: Re(B)=38 nm, Rth(B)=220 nm, and Rth(B)/Re(B)=44.

### Comparative Example A-1

A norbornene film having a thickness of 100 μm was subjected to a tenter transverse stretching at 175° C. The stretch ratio was 1.8 its pre-stretch length in the stretching direction. The thus obtained optically anisotropic layer (A) was 88 μm in thickness, Re(A)=252 nm, Rth(A)=252 nm and Rth(A)/Re(A)=1.0. Similarly, a norbornene film having a thickness of 100 μm was stretched 1.5 times its pre-stretch length so as to obtain an optically anisotropic layer (B) 95 μm in thickness, Re(B)=180 nm, Rth(B)=181 nm and Rth(B)/Re(B)=1.0. Then, an acrylic pressure-sensitive adhesive having a thickness of 15 μm was applied onto the optically anisotropic layer (A), and the optically anisotropic layer (A) and the optically anisotropic layer (B) were bonded to each other so that the respective in-plane slow axes cross each other at right angles. Thereby, a laminated retardation plate (nx>ny>nz) was manufactured.

For the laminated retardation plates obtained in Examples A-1 to A-4 and Comparative Example 1, the thickness and values of the in-plane retardation (Re) and the thickness direction retardation (Rth) were measured. The results are shown in Table 1.

TABLE 1

| | Optically anisotropic layer (A) | | | | Optically anisotropic layer (B) | | | | Laminated retardation plate | | | |
|---|---|---|---|---|---|---|---|---|---|---|---|---|
| | d(A) | Re(A) | Rth(A) | | d(B) | Re(B) | Rth(B) | | d | Re | Rth | |
| | μm | nm | nm | Rth(A)/Re(A) | μm | nm | nm | Rth(B)/Re(B) | μm | nm | Nm | Rth − Re |
| A-1 | 69 | 67 | 136 | 2.9 | 3 | 3 | 110 | 32.7 | 87 | 71 | 248 | 177 |
| A-2 | 64 | 65 | 70 | 1.1 | 5 | 5 | 180 | 36.0 | 69 | 68 | 252 | 184 |
| A-3 | 67 | 30 | 55 | 1.8 | 5 | 40 | 198 | 5.0 | 72 | 70 | 253 | 183 |
| A-4 | 74 | 25 | 50 | 2.0 | 6 | 38 | 220 | 44.0 | 80 | 63 | 270 | 207 |
| A-1* | 88 | 252 | 252 | 1.0 | 95 | 180 | 181 | 1.0 | 183 | 72 | 252 | 180 |

(Note)
A-1, A-2, A-3, A-4 = Examples A-1 to A-4;
A.1* = Comparative Example A-1

As shown in Table 1, for the laminated retardation plate of Comparative Example 1 in which a norbornene film was used for the optically anisotropic layer (B), the thickness must be increased to 183 μm in order to obtain optical properties comparable to those of Examples. On the other hand, regarding the laminated retardation plate in each Example in which polyimide was used for the optically anisotropic layer (B), sufficient optical properties were obtained, and furthermore, the film thickness was decreased to about a half the thickness in Comparative Example A-1.

### Examples B

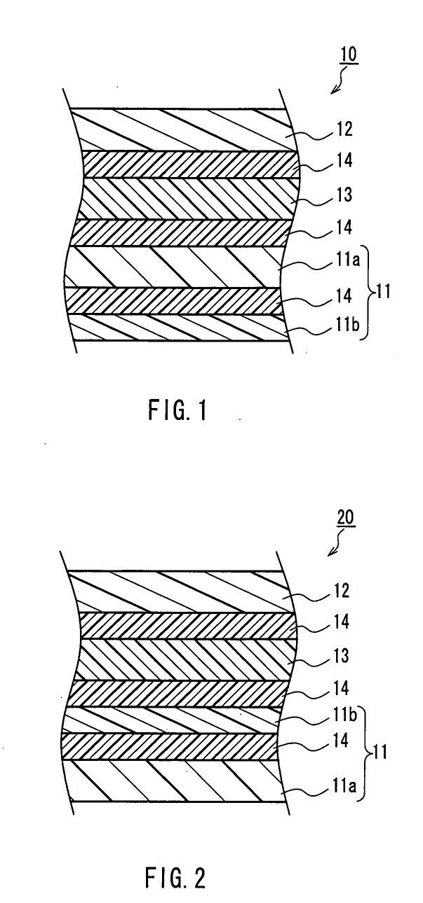

Laminated polarizing plates as shown in FIGS. 1-8 were manufactured. In these drawings, the same members are designated with the same reference numerals.

### Examples B-1

In this example, a laminated polarizing plate 10 as shown in FIG. 1 was manufactured. First, a norbornene film having a thickness of 100 μm was stretched longitudinally at 180° C. The stretch ratio was 1.2 its pre-stretch length in the stretching direction. Thereby, an optically anisotropic layer (A) 11a having a thickness of 90 μm was obtained. Polyimide (weight average molecular weight: 59,000) synthesized from 2,2′-bis(3,4-dicarboxydiphenyl)hexafluoropropane and 2,2′-bis(trifluromethyl)-4,4′-diamino biphenyl was dissolved in cyclohexanone, thereby a 15 wt % polyimide solution was prepared. After coating this polyimide solution on a biaxially stretched PET film, the coating film was dried (temperature: 150° C.; time: 5 minutes), thereby an optically anisotropic layer (B) 11b having a thickness of 5 μm was formed on this stretched PET film. Then, after adhering the optically anisotropic layer (B) 11b on the stretched PET film to the optically anisotropic layer (A) 11a via an acrylic pressure-sensitive adhesive 14 having a thickness of 15 μm, the stretched PET film was peeled off so as to obtain a laminated retardation plate 11 having a thickness of 110 μm.

Furthermore, a polyvinyl alcohol (PVA) film having a thickness of 80 μm was stretched 5 times its original length in an aqueous solution of iodine, which was then dried to obtain a polarizing layer 13. Next, a TAC film 12 having a thickness of 80 μm was adhered to one surface of the polarizing layer 13 via an acrylic pressure-sensitive adhesive layer 14 having a thickness of 15 μm, while the laminated retardation plate 11 was adhered to the other surface so that the optically anisotropic layer (A) 11a would face the polarizing layer 13 side, thereby a wide-viewing-angle laminated polarizing plate 10 having a thickness of 240 μm was obtained.

### Example B-2

In this example, a laminated polarizing plate 20 as shown in FIG. 2 was manufactured. The wide-viewing-angle laminated polarizing plate 20 having a thickness of 240 μm was obtained in the same manner as Example B-1, except that the laminated retardation plate 11 was adhered to the polarizing layer so that the optically anisotropic layer (B) 11b would face the polarizing layer 13 side.

### Example B-3

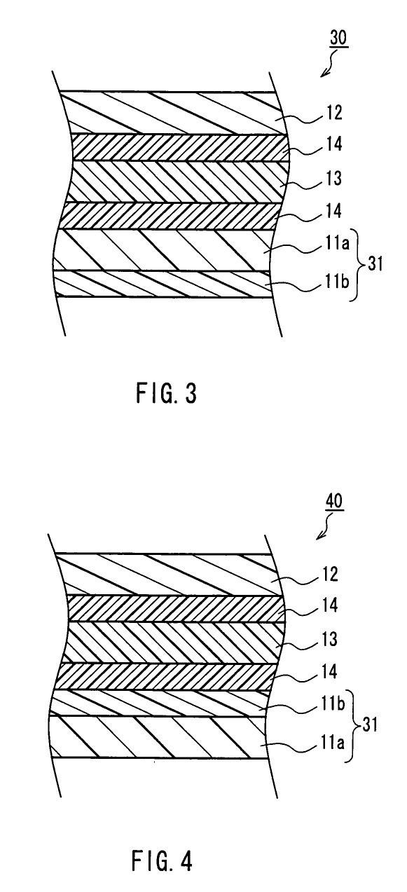

In this example, a laminated polarizing plate 30 as shown in FIG. 3 was manufactured. A polyester film having a thickness of 70 μm was subjected to a tenter transverse stretching (stretch ratio: 1.2) at 160° C. in a stretching direction, thereby an optically anisotropic layer (A) 11a having a thickness of 59 μm was obtained. Next, a polyimide solution prepared in the same manner as Example B-1 was coated on the optically anisotropic layer (A) 11a, and then dried (temperature: 180° C.; time: 5 minutes) to form an optically anisotropic layer (B) 11b having a thickness of 3 μm. Thereby, a laminated retardation plate 31 having a thickness of 62 μm was obtained as a laminate of the optically anisotropic layer (A) 11a and the optically anisotropic layer (B) 11b. Next, via an acrylic pressure-sensitive adhesive layer 14 having a thickness of 15 μm, a TAC film 12 having a thickness of 80 μm was adhered to one surface of the polarizing layer 13 obtained as in Example 1, while the laminated retardation plate 31 was adhered to the other surface so that the optically anisotropic layer (A) 11a would face the polarizing layer 13 side, thereby a wide-viewing-angle laminated polarizing plate 30 having a thickness of 192 μm was obtained.

### Example B-4

In this example, a laminated polarizing plate 40 as shown in FIG. 4 was manufactured. A wide-viewing-angle laminated polarizing plate 40 having a thickness of 192 μm was obtained in the same manner as Example B-3, except that the laminated retardation plate 31 was adhered to the polarizing layer 13 so that the optically anisotropic layer (B) would face the polarizing layer 13 side.

### Example B-5

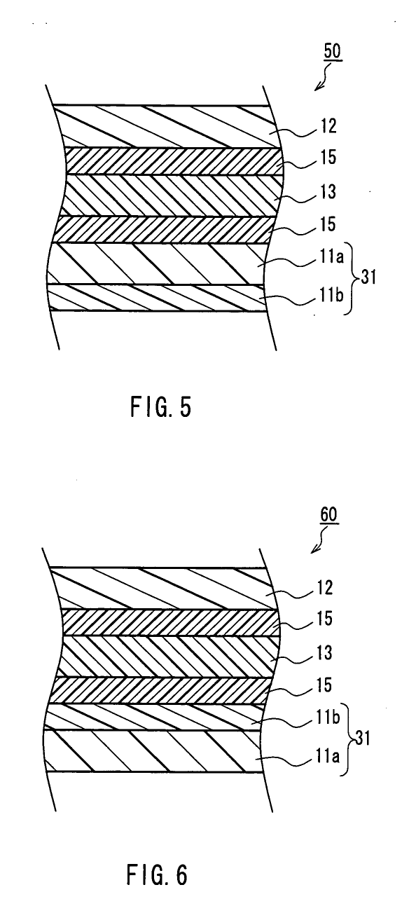

In this example, a laminated polarizing plate 50 as shown in FIG. 5 was manufactured. A polyimide solution prepared in the same manner as Example B-1 was applied onto a TAC film having a thickness of 80 μm, and subjected to a tenter transverse stretching at a stretch ratio of 1.3 while being dried for 5 minutes at a temperature of 190° C. The thus obtained laminated retardation plate 31 was 66 μm in entire thickness, and it included a polyimide film (optically anisotropic layer (B) 11a) having a thickness of 6 μm laminated on a stretched TAC film (optically anisotropic layer (A) 11a) having a thickness of 60 μm. Then, via a PVA-based adhesive layer 15 having a thickness of 5 μm, a TAC film 12 having a thickness of 80 μm was adhered to one surface of the polarizing layer 13 obtained as in Example 1, while the laminated retardation plate 31 was adhered to the other surface so that the optically anisotropic layer (A) 11a would face the polarizing layer 13 side, thereby a wide-viewing-angle laminated polarizing plate 176 having a thickness of 183 μm was obtained.

### Example B-6

In this example, a laminated polarizing plate 60 as shown in FIG. 6 was manufactured. The wide-viewing-angle laminated polarizing plate 60 having a thickness of 176 μm was obtained in the same manner as Example B-5, except that the laminated retardation plate 31 was adhered to the polarizing layer 13 so that the optically anisotropic layer (B) 11b would face the polarizing layer 13 side.

### Example B-7

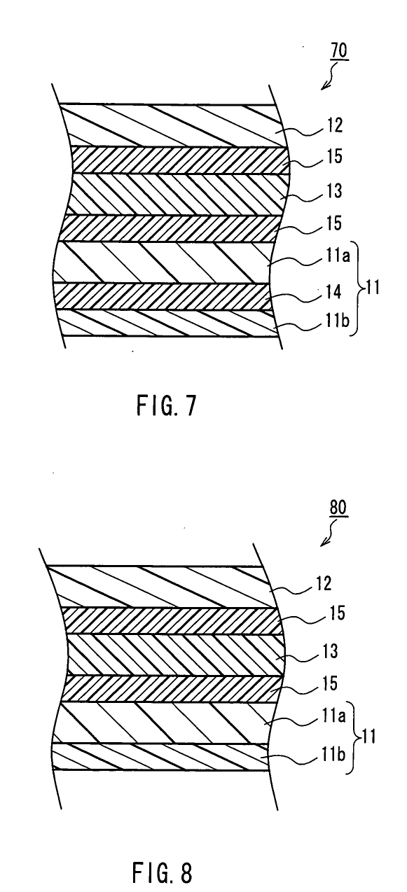

In this example, a laminated polarizing plate 70 as shown in FIG. 7 was manufactured. A TAC film was subjected to a tenter traverse stretching at a stretch ratio of 1.4 at 190° C. so as to obtain an optically anisotropic layer (A) 11a having a thickness of 69 μm. Then, a TAC film 12 having a thickness of 80 μm was adhered to one surface of the polarizing layer 13 obtained as in Example B-1 and the optically anisotropic layer (A) 11a was adhered to the other surface of the polarizing layer 13 respectively via PVA-based adhesive layers 15 having a thickness of 5 μm. Further, an optically anisotropic layer (B) 11b obtained as in Example B-1 was laminated on the optically anisotropic layer (A) 11a via an acrylic pressure-sensitive adhesive 14 having a thickness of 15 μm, and subsequently, the stretched PET film was peeled off to obtain a wide-viewing-angle laminated polarizing plate 70 having a thickness of 199 μm.

### Example B-8

In this example, a laminated polarizing plate 80 as shown in FIG. 8 was manufactured. Polyimide (weight average molecular weight: 65,000), which was synthesized from 4,4′-bis(3,4-dicarboxyphenyl)-2,2-diphenylpropane dianhydride and 2,2′-dichloro-4,4′-diamino biphenyl was dissolved in cyclopentanone, thereby a 20 wt % polyimide solution was prepared. This polyimide solution was coated on a TAC film having a thickness of 80 μm, subjected to a tenter transverse stretching while being dried for 5 minutes at 200° C. The stretch ratio was 1.5 its pre-stretch length in the stretching direction. The thus formed laminated retardation plate was 60 μm in entire thickness, and it included a polyimide film (optically anisotropic layer (B)) having a thickness of 6 μm laminated on a stretched TAC film (optically anisotropic layer (A)) having a thickness of 54 μm. Furthermore, the laminated retardation plate was adhered via a polyvinyl alcohol (PVA)-based pressure-sensitive adhesive layer 15 to one surface of a polarizing layer obtained as in Example B-1 so that the optically anisotropic layer (A) would face, and further, a TAC film 12 having a thickness of 80 μm was adhered to the other surface of the polarizing layer via a PVA-based adhesive layer. Thereby, a wide-viewing-angle laminated polarizing plate having a thickness of 170 μm was obtained.

### Comparative Example B-1

A TAC film having a thickness of 80 μm, Re(A)=0.9 nm, Rth(A)=59 nm, and Rth(A)/Re(A)=66, was used for an optically anisotropic layer (A). A polyimide solution as in Example B-1 was coated thereon, dried at 130° C. for 5 minutes so as to form an optically anisotropic layer (B) on the optically anisotropic layer (A), thereby manufacturing a laminated retardation plate having a thickness of 85 μm and showing nx≈ny>nz. Further, the laminated retardation plate was adhered to one surface of a polarizing layer obtained as in Example B-1 via a polyvinyl alcohol (PVA)-based pressure-sensitive adhesive layer having a thickness of 5 μm such that the optically anisotropic layer (A) would face, and furthermore, a TAC film having a thickness of 80 μm was adhered to the other surface of the polarizing layer via a PVA-based adhesive layer (thickness: 5 μm). Thereby, a wide-viewing-angle laminated polarizing plate having a thickness of 170 μm was obtained.

### Comparative Example B-2

A polyimide solution as in Example B-1 was coated on a polyester film, dried at 130° C. for 5 minutes, and subjected to a tenter traverse stretching at 160° C. at a stretch ratio of 1.1. The polyester film was removed to obtain an optically anisotropic layer (B) made of polyimide. This optically anisotropic layer (B) was 6 μm in thickness, Re(B)=55 nm, Rth(B)=240 nm, and Rth(B)/Re(B)=4.4. To one surface of a polarizing layer obtained as in Example B-1, the optically anisotropic layer (A) was adhered via a polyvinyl alcohol (PVA)-based pressure-sensitive adhesive layer having a thickness of 5 μm, and furthermore, a TAC film having a thickness of 80 μm was adhered to the other surface of the polarizing layer via an acrylic pressure-sensitive adhesive (thickness: 15 I). Thereby, a wide-viewing-angle laminated polarizing plate, not including an optically anisotropic layer (A), was obtained.

### Comparative Example B-3

A TAC film having a thickness of 80 μm was subjected to a tenter transverse stretching to 1.4 times at 190° C., thereby obtaining an optically anisotropic layer (A) having a thickness of 58 μm, Re(A)=40 nm, Rth(A)=46 nm, and Rth(A)/Re(A)=1.2. A polyimide solution as in Example B-1 was coated on a polyester film, dried at 130° C. for 5 minutes, and subjected to a free-end longitudinal stretching to be 1.2 its original length at 160° C., thereby forming an optically anisotropic layer (B) made of polyimide on the polyester film. This optically anisotropic layer (B) was 6 μm in thickness, Re(B)=170 nm, Rth(B)=200 nm, and Rth(B)/Re(B)=1.2. After adhering the optically anisotropic layer (A) to the optically anisotropic layer (B) via an acrylic pressure-sensitive adhesive having a thickness of 15 μm so that these layers would face each other, the polyester film was removed to obtain a laminated retardation plate. This laminated retardation plate was 64 μm in thickness, Re was 210 nm, Rth was 246 nm, Rth/Re was 1.2, and (Rth−Re) was 36 nm. The laminated retardation plate was adhered to one surface of a polarizing layer obtained as in Example B-1 so that the optically anisotropic layer (A) would face, and furthermore, a TAC film having a thickness of 80 μm was adhered to the other surface of the polarizing layer via a PVA-based adhesive layer (thickness: 5 I). Thereby, a wide-viewing-angle laminated polarizing plate having a thickness of 189 μm was obtained.

### Comparative Example B-4

A polarizing layer was obtained in the same manner as Example B-1.

For the optically anisotropic layers (A), the optically anisotropic layers (B) and the laminated retardation plates in the wide-viewing-angle laminated polarizing plates obtained in Examples B-1 to B-8 and Comparative Examples B-1 to B-3, the in-plane retardations, the thickness direction retardations and the like were measured respectively as described above. The results are shown in Table 2 below.

TABLE 2

| | Optically anisotropic layer (A) | | | | Optically anisotropic layer (B) | | | | Laminated retardation plate | | | |
|---|---|---|---|---|---|---|---|---|---|---|---|---|
| | d(A) | Re(A) | Rth(A) | | d(B) | Re(B) | Rth(B) | | d | Re | Rth | |
| | μm | nm | nm | Rth(A)/Re(A) | μm | nm | nm | Rth(B)/Re(B) | μm | nm | nm | Rth − Re |
| B-1 | 90 | 50 | 52 | 1.0 | 5 | 5 | 180 | 36.0 | 95 | 55 | 232 | 177 |
| B-2 | 90 | 50 | 52 | 1.0 | 5 | 5 | 180 | 36.0 | 95 | 55 | 232 | 177 |
| B-3 | 59 | 50 | 144 | 2.9 | 3 | 4 | 91 | 22.8 | 72 | 54 | 235 | 181 |
| B-4 | 59 | 50 | 144 | 2.9 | 3 | 4 | 91 | 22.8 | 72 | 54 | 235 | 181 |
| B-5 | 60 | 30 | 38 | 1.3 | 6 | 22 | 200 | 9.1 | 66 | 52 | 238 | 186 |
| B-6 | 60 | 30 | 38 | 1.3 | 6 | 22 | 200 | 9.1 | 66 | 52 | 238 | 186 |
| B-7 | 58 | 40 | 46 | 1.2 | 5 | 5 | 180 | 36.0 | 78 | 45 | 226 | 181 |
| B-8 | 54 | 33 | 36 | 1.1 | 6 | 25 | 205 | 8.2 | 60 | 59 | 240 | 181 |
| B-1* | 80 | 0.9 | 59 | 66 | 5 | 0.3 | 170 | 567 | 85 | 1 | 229 | 228 |
| B-2* | — | — | — | — | 6 | 55 | 240 | 4.4 | — | 55 | 240 | 185 |
| B-3* | 58 | 40 | 46 | 1.2 | 6 | 170 | 200 | 1.2 | 64 | 210 | 246 | 36 |

(Note)
B-1, . . . B-8 = Examples B-1 to B-8;
B-1* . . . B-3* = Comparative Examples B-1 to B-3

For the wide-viewing-angle laminated polarizing plates obtained in Examples B-1 to B-8 and Comparative Examples B-1 to B-3, and also for the polarizing plate obtained in Comparative Example B-4, the viewing angle properties were evaluated. Polarizing plates were arranged on both surfaces of a VA-type liquid crystal cell so that the transmission axes would cross each other at right angles. The wide-viewing-angle laminated polarizing plate in each Example was arranged so that the laminated retardation plate would face the liquid crystal cell side. In this state, a viewing angle property, which provides Co (contrast) of 10 or more on the display screen of the liquid crystal display, was measured.

The contrast was calculated in the following manner. A white image and a black image were displayed on the liquid crystal display so as to measure the values of Y, x and y in a XYZ display system at the front, vertical, horizontal, diagonal 45° to −225°, and diagonal 135° to −315° of the display, by using an instrument (trade name: Ez contrast 160D, manufactured by ELDIM SA.). Based on the Y-value (Y_{W}) for the white image and the Y-value (Y_{B}) for the black image, the contrast ratio (Y_{W}/Y_{B}) for every viewing angle was calculated. Similarly, for the liquid crystal display as in Comparative Example B-1, which packages the polarizing plate alone in place of the laminated polarizing plate, contrast ratios in the viewing angles were checked. Table 3 below shows ranges of the viewing angles that provide contrasts of 10 or more. Moreover, the display screens of the respective liquid crystal displays were observed visually so as to evaluate coloration of the laminated retardation plates. The results are also shown in Table 3 below.

TABLE 3

| | Viewing angle (°) | | | | |
|---|---|---|---|---|---|
| | | | Diagonal | Diagonal | |
| | Vertical | Horizontal | (45-225) | (135-315) | Coloration |
| Example B-1 | ±80 | ±80 | ±65 | ±65 | No |
| Example B-2 | ±80 | ±80 | ±65 | ±65 | No |
| Example B-3 | ±80 | ±80 | ±60 | ±60 | No |
| Example B-4 | ±80 | ±80 | ±60 | ±60 | No |
| Example B-5 | ±80 | ±80 | ±65 | ±65 | No |
| Example B-6 | ±80 | ±80 | ±65 | ±65 | No |
| Example B-7 | ±80 | ±80 | ±60 | ±60 | No |
| Com. Ex. B-1 | ±80 | ±80 | ±40 | ±40 | No |
| Com. Ex. B-2 | ±80 | ±80 | ±55 | ±55 | Yes |
| Com. Ex. B-3 | ±80 | ±80 | ±40 | ±40 | Yes |
| Com. Ex. B-4 | ±80 | ±80 | ±35 | ±35 | No |

By use of the laminated polarizing plates including the laminated retardation plates of the present invention as shown in Table 2, liquid crystal displays with viewing angles wider than those of the respective Comparative Examples were obtained, as shown in Table 3. In Comparative Example 1, since the optically anisotropic layer (A) cannot compensate the in-plane retardation sufficiently, the in-plane retardation (Re) is smaller than 10 nm. In Comparative Example B-3, since (Rth−Re) is smaller than 50 nm, the viewing angle property for the diagonal deteriorates. In Comparative Example B-3, coloration was identified. In Comparative Example B-2 where an optically anisotropic layer (B) made of polyimide was used alone, the viewing angle properties for the diagonals were not as good as in each Example. Moreover, coloration was identified since the thickness direction retardation was increased by use of the optically anisotropic layer (B) alone. These facts show that use of a wide-viewing-angle laminated polarizing plate according to the present invention can provide a high-definition liquid crystal display that is thinner than a conventional device and excellent in the visibility.

### Industrial Applicability

As described above, a laminated retardation plate of the present invention, whose Re is 10 nm or more and (Rth−Re) is 50 nm or more, is extremely useful, since it is excellent in a wide viewing angle property and decreased in thickness when used in various image displays.

1. A laminated retardation plate comprising at least two optically anisotropic layers,
which comprises an optically anisotropic layer (A) made of polymer, and an optically anisotropic layer (B) made of at least one non-liquid crystalline polymer selected from the group consisting of polyamide, polyimide, polyester, polyaryletherketone, polyether ketone, polyamide imide and polyester imide,
an in-plane retardation (Re) represented by the following equation is not less than 10 nm, and
a difference (Rth−Re) between a thickness direction retardation (Rth) represented by the following equation and the in-plane retardation (Re) is not less than 50 nm:
Re=(nx−ny)·d
Rth=(nx−nz)·d
where nx, ny and nz respectively indicate refractive indices in an X-axis direction, a Y-axis direction and a Z-axis direction in the laminated retardation plate; the X-axis direction is an axial direction showing a maximum refractive index within the plane of the laminated retardation plate, the Y-axis direction is an axial direction perpendicular to the X-axis within the plane, and the Z-axis direction is a thickness direction perpendicular to the X-axis and the Y-axis; and d indicates a thickness in the laminated retardation plate.

2. The laminated retardation plate according to claim 1, wherein the optically anisotropic layer (A) is made of a polymer showing a positive birefringence.

3. The laminated retardation plate according to claim 1, which satisfies the following condition:
nx>ny>nz.

4. The laminated retardation plate according to claim 1, wherein the optically anisotropic layer (B) satisfies the following condition:
nx(B)=ny(B)>nz(B)
where nx(B), ny(B) and nz(B) respectively indicate refractive indices in an X-axis direction, a Y-axis direction and a Z-axis direction in the laminated retardation plate; the X-axis direction is an axial direction showing a maximum refractive index within the plane of the optically anisotropic layer (B), the Y-axis direction is an axial direction perpendicular to the X-axis within the plane, and the Z-axis direction is a thickness direction perpendicular to the X-axis and the Y-axis.

5. The laminated retardation plate according to claim 1, wherein the optically anisotropic layer (B) satisfies the following condition:
nx(B)>ny(B)>nz(B)
where nx(B), ny(B) and nz(B) respectively indicate refractive indices in an X-axis direction, a Y-axis direction and a Z-axis direction in the optically anisotropic layer (B); the X-axis direction is an axial direction showing a maximum refractive index within the plane of the optically anisotropic layer (B), the Y-axis direction is an axial direction perpendicular to the X-axis within the plane, and the Z-axis direction is a thickness direction perpendicular to the X-axis and the Y-axis.

6. The laminated retardation plate according to claim 1, wherein the optically anisotropic layer (A) has an in-plane retardation [Re(A)] represented by the following equation in a range of 20 to 300 nm, and a ratio [Rth(A)/Re(A)] between a thickness direction retardation [Rth(A)] represented by the following equation and the in-plane retardation [Re(A)] of not less than 1.0:
Re(A)=(nx(A)−ny(A))·d(A)
Rth(A)=(nx(A)−nz(A))·d(A)
where nx(A), ny(A) and nz(A) respectively indicate refractive indices in an X-axis direction, a Y-axis direction and a Z-axis direction in the optically anisotropic layer (A); the X-axis direction is an axial direction showing a maximum refractive index within the plane of the optically anisotropic layer (A), the Y-axis direction is an axial direction perpendicular to the X-axis within the plane, and the Z-axis direction is a thickness direction perpendicular to the X-axis and the Y-axis; and d indicates a thickness of the optically anisotropic layer (A).

7. The laminated retardation plate according to claim 5, wherein the optically anisotropic layer (A) has an in-plane retardation [Re(A)] represented by the following equation in a range of 20 to 300 nm, and a ratio [Rth(A)/Re(A)] between a thickness direction retardation [Rth(A)] represented by the following equation and the in-plane retardation [Re(A)] of not less than 1.0; and the optically anisotropic layer (B) has an in-plane retardation [Re(B)] represented by the following equation of not less than 3 nm and a ratio [Rth(B)/R.e(B)] between a thickness direction retardation [Rth(B)] represented by the following equation and the in-plane retardation [Re(B)] of not less than 1.0:
Re(A)=(nx(A)−ny(A))·d(A)
Rth(A)=(nx(A)−nz(A))·d(A)
Re(B)=(nx(B)−ny(B))·d(B)
Rth(B)=(nx(B)−nz(B))·d(B)
where nx(A), ny(A) and nz(A) respectively indicate refractive indices in an X-axis direction, a Y-axis direction and a Z-axis direction in the optically anisotropic layer (A) while nx(B), ny(B) and nz(B) respectively indicate refractive indices in an X-axis direction, a Y-axis direction and a Z-axis direction in the optically anisotropic layer (B); the X-axis direction is an axial direction showing a maximum refractive index within the plane of each of the optically anisotropic layers, the Y-axis direction is an axial direction perpendicular to the X-axis within the plane, and the Z-axis direction is a thickness direction perpendicular to the X-axis and the Y-axis; d(A) indicates a thickness of the optically anisotropic layer (A), and d(B) indicates a thickness of the optically anisotropic layer (B).

8. The laminated retardation plate according to claim 1, wherein the optically anisotropic layer (A) is made of a thermoplastic polymer.

9. The laminated retardation plate according to claim 8, wherein the optically anisotropic layer (A) comprises a stretched film.

10. The laminated retardation plate according to claim 1, wherein a pressure-sensitive adhesive layer is further laminated on at least one outermost layer.

11. A laminated polarizing plate comprising an optical film and a polarizer, wherein the optical film comprises the laminated retardation plate according to claim 1.

12. The laminated polarizing plate according to claim 11, wherein a pressure-sensitive adhesive layer is further laminated on at least one outermost layer.

13. A liquid crystal panel comprising a liquid crystal cell and an optical member, the optical member being arranged on at least one surface of the liquid crystal cell, wherein the optical member is the laminated retardation plate according to claim 1.

14. A liquid crystal display comprising the liquid crystal panel of claim 13.

15. A self-light-emitting display comprising the laminated retardation plate according to claim 1.

16. A liquid crystal panel comprising a liquid crystal cell and an optical member, the optical member being arranged on at least one surface of the liquid crystal cell,
wherein the optical member is the laminated polarizing plate according to claim 11.

17. A self-light-emitting display comprising the laminated polarizing plate according to claim 11.
